(19) United States
(12) Patent Application Publication
(10) Pub. No.: US 2025/0373911 A1
(43) Pub. Date: Dec. 4, 2025

(54) Video-Assisted networking Platforms and Methods of Networking Using the Same

(71) Applicant: OLIV Network Inc., Woodbridge (CA)

(72) Inventor: Olivia Alexandria Aversa, Woodbridge (CA)

(73) Assignee: OLIV Network Inc., Woodbridge (CA)

(21) Appl. No.: 19/223,677

(22) Filed: May 30, 2025

Related U.S. Application Data
(60) Provisional application No. 63/654,265, filed on May 31, 2024.

(51) Int. Cl. H04N 21/854

(52) U.S. Cl. CPC H04N 21/854

(57) ABSTRACT

A video-assisted networking platform for networking by users that includes: a host network platform server; a host networking platform software installed on the server and configured for access by the users; and video resumes stored on the server, each authored by one of the users and comprising searchable user-authored content in a format specified by the software. The software is configured such that each video resume can be generated and modified by one of the users. Further, the software is configured such that one of the users can evaluate each video resume based at least in part on its searchable user-authored content. In addition, the software is configured such that each of the video resumes can be authenticated by one of the users. Further, the software is configured with a conversion component capable of converting raw user-authored video content into the searchable content.

### CROSS-REFERENCE TO RELATED APPLICATION

This application is a non-provisional U.S. patent application that claims the benefit of priority under 35 U.S.C. § 119(e) of U.S. Provisional Patent Application No. 63/654,265, entitled “Networking Platform”, filed on May 31, 2024, the contents of which is relied upon and incorporated herein by reference in its entirety.

### FIELD

The present disclosure relates generally toward an improved networking platform. More specifically, the present disclosure relates toward a video-assisted networking platform for networking by users, recruiting by candidates and recruiters, and other functions, along with methods of using the same.

### BACKGROUND

Networking platforms have been in use since the advent of the internet. Networking platforms have been known to provide an interface between potential employee candidates and employers in a variety of disciplines. These platforms have also been used to connect various business interests in a convenient manner. However, to date, known platforms have been difficult to use and have only provided moderate ability to connect interested parties. Many known platforms are not effective at bringing together parties interested in connecting based on common interests, experience and/or skills.

Furthermore, information available about open positions, and candidates for those positions, is often limited requiring alternative measures to be adopted to obtain necessary information to evaluate the suitability of a candidate for an available position. From the standpoint of the candidate, current systems often require time-intensive, job-seeking efforts. Many systems with active job postings necessitate the laborious creation of a particular digital resume by a candidate tailored for each posting of interest. From the standpoint of the recruiter, these tailored digital resumes often provide very little authentic information for a recruiter to evaluate the suitability of the candidate for the posting.

Conventional networking and recruiting systems are also facing the problem that some of their users, and the content provided by them, are not authentic and/or not human-authored. Such systems lack safeguards to ensure that digital resumes and profiles of users are authentic and not partially or fully derived from generative artificial intelligence (GAI) platforms, software, add-ons, etc. Moreover, conventional networking systems often allow users too much freedom to edit and alter digital and video resumes, resulting in an inauthentic product that is not an accurate reflection of the abilities of a candidate and less useful from the standpoint of recruiters. Even with safeguards in place, it is becoming extremely difficult for a recruiter to evaluate a digital resume in a manner that ensures that the user content is authentic to the user.

Therefore, there is a need for an improved networking platform that facilitates the efficient creation of authentic, user-authored information to connect interested parties for business, recruiting and other purposes.

### SUMMARY

According to an aspect of the disclosure, a video-assisted networking platform for networking by users with accounts on the platform is provided that includes: a host network platform server; a host networking platform software installed on the server and configured for access by each of the users; and a plurality of video resumes stored on the server, each video resume authored by one of the users and comprising searchable user-authored content in a video resume format specified by the platform software. The host networking platform software is configured such that each video resume can be generated and modified by one of the users. Further, the host networking platform software is configured such that one or more of the users can evaluate each of the plurality of video resumes based at least in part on the searchable user-authored content of each of the video resumes. In addition, the searchable user-authored content is derived from raw user-authored video content. Further, the host networking platform software is configured such that each of the plurality of video resumes can be authenticated by one of the users. The host networking platform software is also configured with a conversion component capable of converting the raw user-authored video content into the searchable user-authored content.

According to an aspect of the disclosure, a video-assisted networking platform for candidates and recruiters, each with accounts on the platform, is provided that includes: a host network platform server; a host networking platform software installed on the server and configured for access by each of the candidates and recruiters; and a plurality of video resumes stored on the server, each video resume authored by one of the candidates and comprising searchable user-authored content in a video resume format specified by the platform software, the searchable content comprising textual content. The host networking platform software is configured such that each video resume can be generated and modified by one or more of the candidates. The host networking platform software is configured such that one of the recruiters associated with an open position can evaluate each of the plurality of video resumes against the open position based at least in part on the searchable user-authored content of each of the plurality of video resumes. Further, the textual content comprises a plurality of resume topic headings configured to organize the searchable user-authored content. In addition, the host networking platform software is configured such that each of the plurality of video resumes can be authenticated by one of the candidates. Further, the resume topic headings can be based on input from the one of the recruiters.

According to an aspect of the disclosure, a method of networking using a video-assisted networking platform, the networking platform for networking by candidates and recruiters, each with accounts on the platform, is provided that includes: accessing the networking platform by use of one of the accounts of the recruiters on the platform, the platform comprising a host networking platform software installed on a host network platform server; designating a video resume format on the platform software based at least in part on an open position, the designating conducted during the step of accessing the networking platform by use of one of the accounts of the recruiters; accessing the networking platform by use of one of the accounts of the candidates; recording a video resume using the host networking platform software for storage on the host network platform server, the recording conducted during the step of accessing the networking platform by use of one of the accounts of the candidates; evaluating the video resume against the open position using the host networking software and by accessing the networking platform by use of the one of the accounts of the recruiters; and authenticating the video resume using the host networking platform software, the authenticating conducted during the step of accessing the networking platform by use of one of the accounts of the candidate. The designating a video resume format step is conducted before the recording a video resume step. Further, the video resume comprises searchable user-authored content derived from raw user-authored video content in a video resume format provided by the host networking platform software. In addition, the evaluating the video resume step is conducted based at least in part on the searchable user-authored content of the video resume.

Additional features and advantages will be set forth in the detailed description which follows, and in part will be readily apparent to those skilled in the art from that description or recognized by practicing the embodiments as described herein, including the detailed description which follows, the claims, as well as the appended drawings.

### BRIEF DESCRIPTION OF THE DRAWINGS

It is to be understood that both the foregoing general description and the following detailed description are merely exemplary, and are intended to provide an overview or framework to understanding the nature and character of the claims. The accompanying drawings are included to provide a further understanding, and are incorporated in and constitute a part of this specification. The drawings illustrate one or more embodiments, and together with the description serve to explain principles and operation of the various embodiments, wherein:

FIG. 1 is a schematic of a video-assisted networking platform for networking by users with accounts on the network, according to one or more embodiments of the disclosure;

FIGS. 1A and 1B are schematics of the host networking software of the networking platform of FIG. 1, as employed by users to generate and authenticate video resumes stored on the server of the platform and users to evaluate these resumes, respectively, according to one or more embodiments of the disclosure;

FIG. 2 is a schematic of a video-assisted networking platform for candidates and recruiters, each with accounts on the network, according to one or more embodiments of the disclosure;

FIGS. 2A and 2B are schematics of the host networking software of the networking platform of FIG. 2, as employed by candidates to generate and authenticate video resumes stored on the server of the platform and recruiters to evaluate these resumes, respectively, according to one or more embodiments of the disclosure;

FIG. 3 is a schematic flow chart of a method of networking using the video-assisted platform of FIG. 1 or FIG. 2, according to embodiments of the disclosure;

FIG. 4 is a schematic of the host networking platform software, according to one or more embodiments of the disclosure;

FIG. 5 shows a webpage of the central dashboard of the networking platform software of FIG. 4, according to an embodiment of the disclosure;

FIGS. 5A and 5B each show a webpage of an alternative central dashboard of the networking software of FIG. 4, according to embodiments of the disclosure;

FIG. 5C shows a webpage of the central dashboard of the networking platform software of FIG. 4 with a networking invitation, according to an embodiment of the disclosure;

FIG. 6 shows a webpage of the user profile of the central dashboard of the networking platform software of FIG. 4, according to an embodiment of the disclosure;

FIGS. 6A and 6B show a webpage of the user profile of FIG. 6 with a live resume and an employment listing button, respectively, according to embodiments of the disclosure;

FIG. 7 shows a webpage of the live resume aspect of the central dashboard of the networking platform software of FIG. 4, according to an embodiment of the disclosure;

FIGS. 7A-7C each show a webpage of the live resume aspect of the central dashboard of the networking platform software of FIG. 4 with a sign language button and separate video content for a recruiter to “meet” the candidate, “get to know” the candidate and “what makes the particular candidate a stand-out candidate”, respectively, according to embodiments of the disclosure;

FIGS. 7D-7F each show a webpage of the live resume aspect of the central dashboard of the networking platform software of FIG. 4 with a user's (e.g., a candidate) previous work history button, educational background button, and interests button, respectively, according to embodiments of the disclosure;

FIG. 8 shows a webpage of the networking aspect of the central dashboard of the networking platform software of FIG. 4, as configured with communication buttons for contacting a user, according to one or more embodiments of the disclosure;

FIG. 9 shows a webpage of a company specific dashboard of the central dashboard of the networking platform software of FIG. 4, according to one or more embodiments of the disclosure; and

FIG. 10 shows a webpage of the live feed aspect of the central dashboard of the networking platform software of FIG. 4, as configured for contacting a defined network of users, according to one or more embodiments of the disclosure.

### DETAILED DESCRIPTION

In the following detailed description, for purposes of explanation and not limitation, example embodiments disclosing specific details are set forth to provide a thorough understanding of various principles of the present disclosure. However, it will be apparent to one having ordinary skill in the art, having had the benefit of the present disclosure, that the present disclosure may be practiced in other embodiments that depart from the specific details disclosed herein. Moreover, descriptions of well-known devices, methods and materials may be omitted so as not to obscure the description of various principles of the present disclosure. Finally, wherever applicable, like reference numerals refer to like elements.

Ranges can be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

Directional terms as used herein—for example “up,” “down,” “right,” “left,” “front,” “back,” “top,” “bottom”—are made only with reference to the figures as drawn and are not intended to imply absolute orientation.

Unless otherwise expressly stated, it is in no way intended that any method set forth herein be construed as requiring that its steps be performed in a specific order. Accordingly, where a method claim does not actually recite an order to be followed by its steps, or it is not otherwise specifically stated in the claims or descriptions that the steps are to be limited to a specific order, it is in no way intended that an order be inferred, in any respect. This holds for any possible non-express basis for interpretation, including matters of logic with respect to arrangement of steps or operational flow, plain meaning derived from grammatical organization or punctuation, and the number or type of embodiments described in the specification.

As used herein, the singular forms “a,” “an” and “the” include plural referents unless the context clearly dictates otherwise. Thus, for example, reference to a “component” includes aspects having two or more such components, unless the context clearly indicates otherwise.

In general, the video-assisted networking platform of the disclosure is for networking by users with accounts on the platform. The platform is also for networking and recruiting by candidates and recruiters, each with accounts on the platform. Further, the networking platform includes a host network platform server, a host networking platform software installed on the server, and multiple video resumes stored on the server, each video resume authored by a user or candidate. All of the users, candidates and recruiters with accounts have access to the platform. Further, the software is configured such that one or more of the users or recruiters can evaluate each of the video resumes based at least in part on the searchable content in each of the video resumes.

The video-assisted networking platform of the present disclosure enables networking, recruitment, mentorship, and skill development, all within a simplified internet portal of the type not previously available, that is implemented on both conventional computers and mobile devices. Further, the present disclosure relates toward a video-assisted networking platform for networking by users, recruiting by candidates and recruiters, and other functions, along with methods of using the same. The improved networking platform facilitates the efficient creation of authentic, user-authored information, e.g., video resumes with searchable content, to connect interested parties for business, recruiting and other purposes.

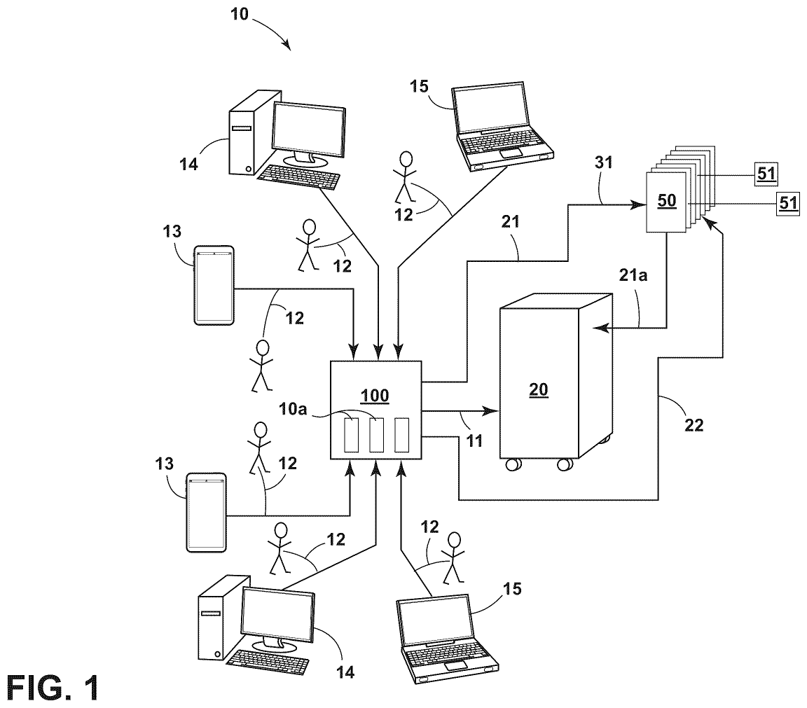

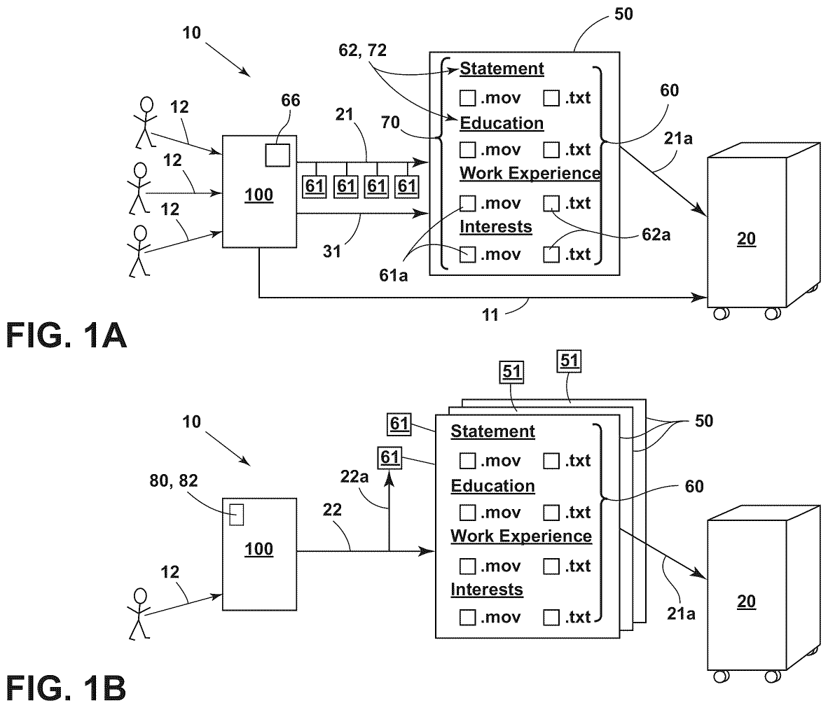

Referring now to FIGS. 1-1B, a schematic is provided of a video-assisted networking platform 10 for networking by users 12 with accounts 10a on the platform. As depicted in FIG. 1, the platform 10 includes: a host network platform server 20; a host networking platform software 100 installed on the server 20 and configured for access by each of the users 12; and a plurality of video resumes 50 stored on the server 20. In some embodiments, the host networking platform software 100 is installed on the server 20 according to an installation process 11 (see also FIG. 1A), which can be conducted according to any software storage process understood by those skilled in the field of the disclosure. In some embodiments, the video resumes 50 are stored on the server 20 according to a storing process 21a, initiated by a user 12 or the software 100 (see also FIGS. 1A and 1B).

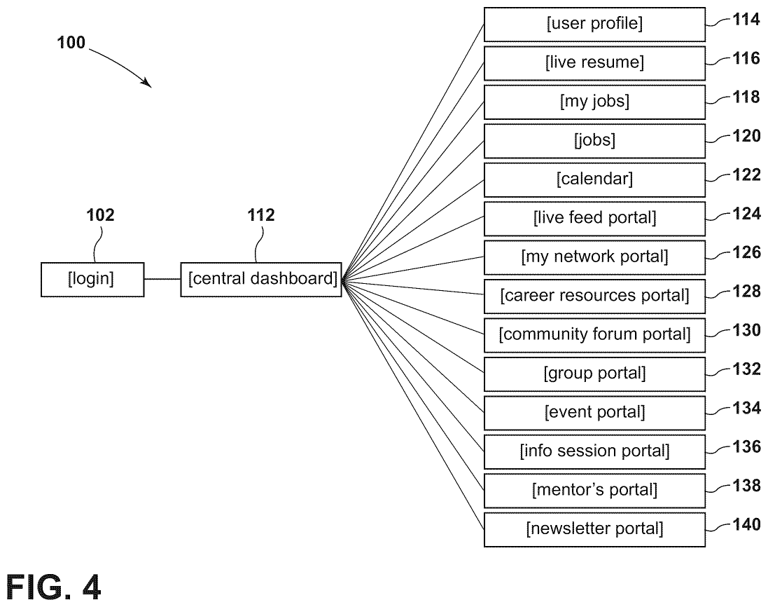

Referring again to FIGS. 1-1B, users 12 with accounts 10a on the video-assisted networking platform 10 can access its host networking platform software 100 using any of a variety of devices. These devices can include one or more of mobile phone devices 13, desktop computers 14, laptop computers 15, and any other devices or systems capable of running the networking platform software 100 or otherwise interfacing with software 100, as installed on the server 20. Further, according to some embodiments of the networking platform 10, versions of the host networking platform software 100 may be installed on any of these devices, e.g., to improve connectivity and efficiency of the networking platform 10. Moreover, as is evident from FIG. 1, various users 12 may interact with the platform 10 by use of their respective accounts 10a on the host networking platform software 100, e.g., as installed on the host network platform server 20. Access, functionality and embodiments of the platform software 100 are depicted in FIGS. 4-10, as described in detail later in this disclosure.

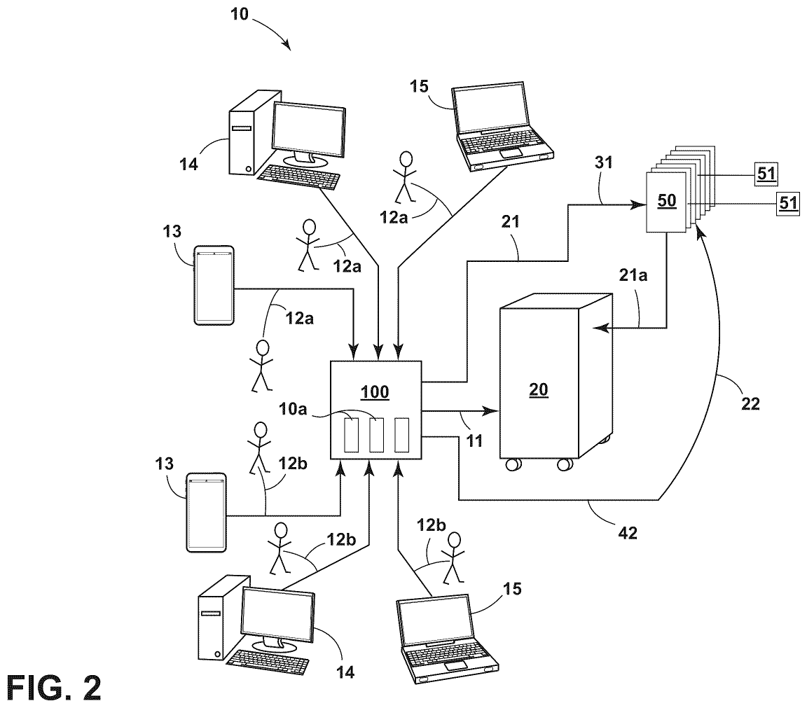

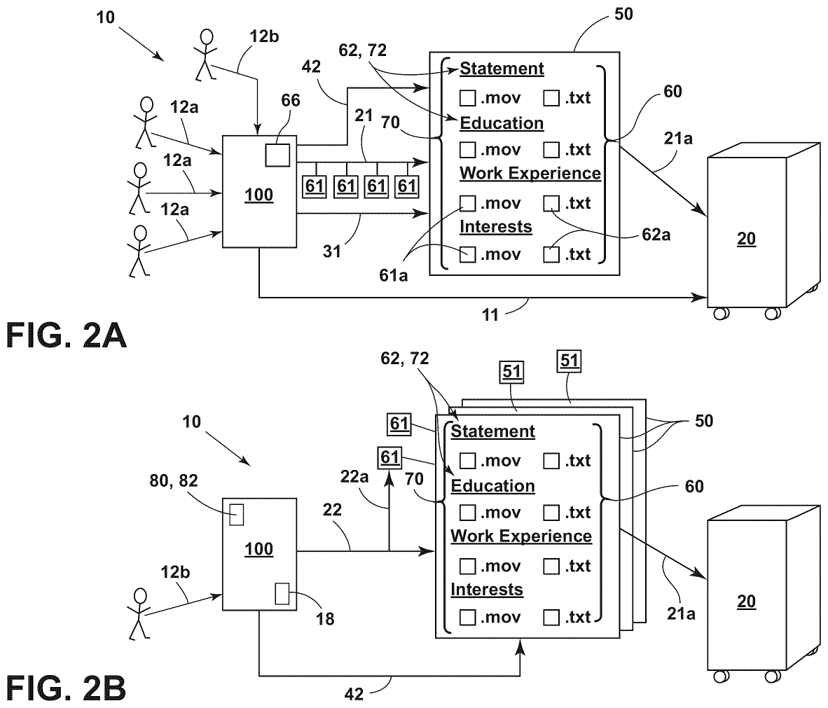

The server 20, as employed in the networking platform 10 and depicted in exemplary form in FIGS. 1-1B, can be any suitable device or system for storing and retrieving various types of data, e.g., video resumes 50; running software, including the host networking platform software 100; connecting to the internet for access by users 12 with accounts 10a on the platform 10; and suitable for running continuously and reliably with standard power (e.g., 120V AC). Accordingly, the server 20 can be any device or system to handle these functions, as understood by those skilled in the field of this disclosure. In some implementations of the networking platform 10, some of the users 12 are candidates 12a for an open position 18 and/or some of the users 12 are recruiter(s) 12b responsible for the open position 18 (see FIGS. 2-2B, and corresponding description below). As used in this disclosure, “users” (also interchangeably referred to as “members” in the disclosure) include any individual making use of the video-assisted networking platform 10, including users 12, candidates 12a, and recruiters 12b.

Referring again to FIGS. 1-1B, each video resume 50 of the video-assisted networking platform 10, e.g., as stored on the server 20, is authored by one of the users 12. Further, each video resume 50 comprises searchable user-authored content 60 in a video resume format 70 specified by the platform software 100. The host networking platform software 100 is configured such that each video resume 50 can be generated and modified by one of the users 12. In some embodiments, each video resume 50 is generated and/or modified by one of the users 12 by use of the software 100 according to a video resume creation process 21 (see FIG. 1A, as described further below), e.g., with the software 100 prompting the user 12 in the creation of one or more video files that correspond to the prescribed video resume format 70. For example, the prescribed video resume format 70 of the software 100 can guide the user 12 in the creation of various video files that make up the video resume 50, each such file corresponding to the user's work statement, experience, skills, interests, education, etc.

Still referring to FIGS. 1-1B, each of the video resumes 50, e.g., as stored on the server 20, is authored by a user 12 with an account 10a on the networking platform 10. As used in this disclosure, a “video resume” (also interchangeably referred to as a “live resume”), such as video resume 50, is a resume, curriculum vitae, or profile created or otherwise recorded by a user 12 with at least one video component. The video component(s) of the video resume 50 can be files of various lengths, suitable for play in various formats (e.g., *.mov, *.avi, *.mp4, *.mkv, *.wmv, etc.). In some embodiments, the video resume 50 is recorded by a user using any device suitable for recording video, e.g., mobile phone, camcorder, video camera, laptop with a camera, as would be understood by those skilled in the field of the disclosure. Accordingly, the video resume 50 can include other media types associated with the resume of a user, including text, imagery, audio and other media. Further, according to embodiments of the networking platform 10, each video resume 50 contains one or more video components, each with a varying length. In some implementations, the video component(s) of the video resume 50 are recorded by a user 12 to correspond to various profile-related aspects of the user 12, e.g., background, statement of interest, work experience, education, skills, fluent language(s), technical proficiencies, community work, interests, etc.

Referring again to FIGS. 1-1B, each of the video resumes 50, e.g., as stored on the server 20 of the networking platform 10, includes searchable user-authored content 60. As used in this disclosure, “searchable user-authored content”, e.g., searchable user-authored content 60, is any user-authored content of a video resume, e.g., video resume 50, that can be searched by any of various conventional search engines, artificial intelligence (AI) software, machine learning algorithms, etc. as understood by those skilled in the field of the disclosure. Searchable user-authored content 60 can include, but is not limited to, one or more of the following types of material: textual content 62 (e.g., one or more text files), raw user-authored video content 61 (e.g., one or more video files authored by a user 12 or candidate 12a (see FIGS. 2-2B)), processed video content 61a (e.g., one or more video files with metadata, textual and/or temporal markers, as converted from raw user-authored video content 61), audio files (not shown), image files (not shown), graphic files (not shown), and other multimedia file types (see also FIGS. 1A and 1B). Further, the searchable content 60 is derived from raw-user authored video content 61, which means that it may solely contain raw user-authored video content 61, some raw user-authored video content 61, or no raw user-authored video content 61. In instances where the searchable content 60 contains no raw user-authored video content 61, the searchable content 60 will include other types of content that is derived from the raw user-authored video content 61 (e.g., processed video content 61a, textual content 62, image files, graphic files, audio files, etc.). It should be understood that any such raw user-authored video content 61 that constitutes searchable content 60 is capable of being searched (e.g., based on its temporal components, metadata, etc.).

Referring again to FIGS. 1-1B, the host networking platform software 100 of the networking platform 10 is configured with a conversion component 66 that is capable of converting some or all of the raw user-authored video content 61 into the searchable user-authored content 60, e.g., by adding metadata, temporal components or other searchable material to such raw video content during or after creation by the user 12 or candidate 12a (see FIGS. 2-2B). Further, in some implementations, the searchable content 60 includes processed video content 61a, as derived from raw user-authored video content 61. According to some embodiments, the searchable content 60 of a video resume 50 can include raw user-authored video content 61 and/or processed video content 61a, each content type capable of being searched based on their temporal components, metadata and/or as converted by the software 100 or other algorithm into a searchable form (e.g., video-to-text transcription).

With further reference to FIGS. 1-1B, each of the video resumes 50, e.g., as stored on the server 20 of the networking platform 10, can be arranged in a video resume format 70. In some implementations of the networking platform 10, the video resume format 70 for each of the video resumes 50 is specified by the host networking platform software 100. In other implementations, the video resume format 70 is set by a user 12, either the user 12 (e.g., a candidate 12a, as shown in FIGS. 2-2B) that is creating the video resume 50 or another user 12 (e.g., a recruiter 12b, as shown in FIGS. 2-2B). Further, the video resume format 70 can be any of various arrangements of the video resume 50 suitable for organizing its content into a form suitable for networking, job-seeking, and/or marketing by the user 12 or candidate 12a. In some implementations, the video resume format 70 is conveyed to a user 12 or candidate 12a by the host networking platform software 100 as a visual format to guide the preparation of searchable content, e.g., by screens that prompt the user 12 or candidate 12a to record particular profile-related information, e.g., a video file, that corresponds to background, location, interests, experience, etc. In some implementations, the video resume format 70 is an organizational arrangement of the content of the video resume 50 file, as viewed by a user 12 or candidate 12a within the software 100 or as opened by another software.

Still referring to FIGS. 1-1B, the host networking platform software 100 of the networking platform 10 is configured such that each of the plurality of video resumes 50, e.g., as stored on the server 20, can be authenticated by one of the users 12. The networking platform 10 of the disclosure also contemplates the use of an authentication process 31 in connection with the authentication aspect of the software 100 (see also FIG. 1A). Further, the networking software 100 can be configured with any of various authentication components, as would be understood by those skilled in the field of the disclosure, suitable for ensuring that a video resume 50 created by a user 12 is user-authored and not otherwise created by, altered by or otherwise influenced by a non-authorized user of the networking platform 10, the result of a generative artificial intelligence query, algorithm, or any other non-human video resume creation source, algorithm or scheme. In some embodiments, the host networking platform software 100 is configured such that each of the video resumes 50, as stored on the server 20, can be authenticated by one of the users 12 as constituting raw user-authored video content 61 generated in one take (i.e., each raw video content file is generated in a single take without further editing), much as one would deliver during a live interview. Suitable authentication components, approaches, algorithms, widgets and/or add-ons employed by the software 100 include a two-factor authentication scheme for use by the user 12, a passkey provided to the user 12, a quick-response (QR) code that can be scanned by a device owned by the user 12, a fingerprint scanning and recognition scheme, and generative AI or machine learning algorithms configured to detect inauthentic video content within a video resume 50. Any such authentication approaches, according to embodiments, can be activated or effected during set up of an account 10a on the network 10 by a user 12.

Still referring to FIGS. 1-1B, the host networking platform software 100 of the networking platform 10 is configured such that one or more of the users 12 (or recruiters 12a, as shown in FIGS. 2-2B and described further below) can evaluate each of the plurality of video resumes 50 based at least in part on the searchable user-authored content 60 of each of the video resumes 50. The networking platform 10 of the disclosure also contemplates an evaluation process 22 in connection with the evaluation aspect of the software 100 (see also FIG. 1B, as described in further detail below). Further, the networking software 100 can be configured with any of various searching components, approaches, algorithms, widgets and/or add-ons, as would be understood by those skilled in the field of the disclosure, suitable for evaluating and searching the searchable content 60 of a plurality of video resumes 50, as stored on the server 20 of the networking platform 10. Suitable evaluation and/or search components, approaches, algorithms, widgets and/or add-ons of the software 100 include a built-in search engine (e.g., Microsoft® Windows Search, File Explorer, etc.), an AI-powered assistant (e.g., Microsoft® Copilot®, Google® Bard®, Google® Gemini®, etc.), and a third-party search tool (e.g., Everything). For example, the software 100 is advantageously configured such that a user 12 or recruiter 12b can evaluate the searchable content 60 (e.g., textual content 62, raw user-authored video content 61, processed video content 61a, etc.) of the plurality of video resumes 50 to engage in further networking, job position review, etc. with the user(s) 12 or candidate(s) 12a that authored one or more video resumes 50 of interest.

According to some embodiments of the networking platform 10, as depicted in exemplary form in FIGS. 1-1B, the searchable content 60 of a video resume 50 can include textual content 62 (e.g., one or more text files, text, metadata, etc.), all of which can be directly searchable. In some implementations, the textual content 62 of a video resume 50 includes one or more resume topic headings 72, as configured to organize the searchable user-authored content 60 (see FIGS. 1A and 1B). Such resume topic headings 72 can include, for example, a statement, education, work experience, interests, and/or headings suitable to organize a resume, profile or curriculum vitae. In an implementation, the searchable user-authored content 60 consists of textual content 62 and processed video content 61a, with the video content 61a being derived from the raw user-authored video content 61.

According to some embodiments of the networking platform 10, again as depicted in exemplary form in FIGS. 1-1B, textual content 62 of the searchable content 60 of a video resume 50 can comprise processed textual passages 62a, as derived from raw user-authored video content 61. In such embodiments, the software 100 is configured to handle the video-to-text transcription for converting the raw user-authored video content 61 into processed textual passages 62a. As would be understood by those skilled in the field of the disclosure, the software 100 can be configured with any of various video-to-text transcription components, add-ons, widgets, algorithms, and/or approaches suitable to convert raw user-authored video content 61 into processed textual passages 62a. Thus, as a user 12 or candidate 12a (see FIGS. 2-2B) records various video components, files, etc. in the course of creating the video resume 50 using the software 100, the transcription component of the software 100 can be deployed to effect transcription of such video components, files, etc. into text.

Referring again to the networking platform 10, as depicted in exemplary form in FIGS. 1-1B, embodiments of the platform 10 employ host networking software 100 configured such that a user 12 or a recruiter 12b (see FIGS. 2-2B) can evaluate the raw user-authored video content 61 of each of the plurality of video resumes 50, as stored on the server 20, with a machine learning component 80 against a communication-oriented criterion 82. The networking platform 10 of the disclosure also contemplates the use of an evaluation process 22a in connection with the use of the machine learning component aspect of the software 100 (see also FIG. 1B, described in further detail below). The machine learning component 80 can be any generative AI or AI-driven add-on capable of reviewing raw user-authored video content 61 against a user-provided criterion or query, such as a communication-oriented criterion 82. In some aspects of the networking platform 10, the communication-oriented criterion 82 is established by a user 12 or recruiter 12b to gauge the communication skills (e.g., fluency in a designated language, use of active voice, vocabulary, etc.), body language, and other behaviors of the user 12 or candidate 12a (see FIGS. 2-2B) that authored each of the video resumes 50.

Referring now to FIG. 1A, a schematic of the host networking software 100 of the networking platform 10 is provided, as employed by users 12 to generate video resumes 50 stored on the server 20 of the platform 10. As shown, each video resume 50 can be generated and/or modified by one of the users 12 by use of the software 100 according to a video resume creation process 21. Further, each video resume 50 includes user-authored searchable content 60 in a video resume format 70, as specified by the software 100. For example, the software 100 can prompt the user 12 in the creation of one or more video files (e.g., *.mov files) that correspond to the prescribed video resume format 70. In some embodiments, the prompts or sets of questions provided by the software 100 are available to the user 12 only at the time the user 12 begins recording the video resume 50, e.g., to drive authenticity in the creation of the content of the video resume 50. In other embodiments, the prompts or sets of questions provided by the software 100 are varied for each user 12 on a random basis or according to a prescribed pattern (e.g., with 3-4 versions), e.g., to drive authenticity in the creation of an authentic, video resume 50. The searchable content 60, as shown, can also include textual content 62 (e.g., metadata, resume headings, etc.) and, in some embodiments, the textual content 62 can include resume headings 72 (e.g., statement, education, work experience, and interests). In some implementations, the searchable content 60 can include textual content 62 and processed video content 61a (e.g., *.mov files). The textual content 62 can also include processed textual passages 62a, derived from raw user-authored video content 61.

Referring now to FIG. 1B, a schematic of the host networking software 100 of the networking platform 10 is provided, as employed by users 12 to evaluate video resumes 50, as stored on the server 20 of the platform 10. As shown, the host networking platform software 100 of the networking platform 10 is configured such that one or more of the users 12 can evaluate each of the plurality of video resumes 50 based at least in part on the searchable user-authored content 60 of each of the video resumes 50. The networking platform 10 of the disclosure also contemplates an evaluation process 22, as shown, in connection with the evaluation aspect of the software 100. In particular, the networking software 100 can be configured with any of various searching components, approaches, algorithms, widgets and/or add-ons, as would be understood by those skilled in the field of the disclosure, suitable for evaluating and searching the searchable content 60 of a plurality of video resumes 50, as derived from the raw user-authored video content 61. As also shown in FIG. 1B, the networking platform 10 of the disclosure also contemplates the use of an evaluation process 22a in connection with a machine learning component aspect of the software 100. The machine learning component 80 can be any generative AI or AI-driven add-on capable of reviewing raw user-authored video content 61 against a user-provided criterion or query, such as a communication-oriented criterion 82. That is, in some implementations, the user 12 can evaluate the searchable content 60 of the video resumes 50 that comprises or consists of raw video content 61, e.g., to assess the communication skills of another user 12 (e.g., a candidate 12a, as shown in FIGS. 2-2B) against some criterion, e.g., some desire or interest of the user 12 to screen other users 12 for networking based on communication-related skills, techniques, language fluency, etc.

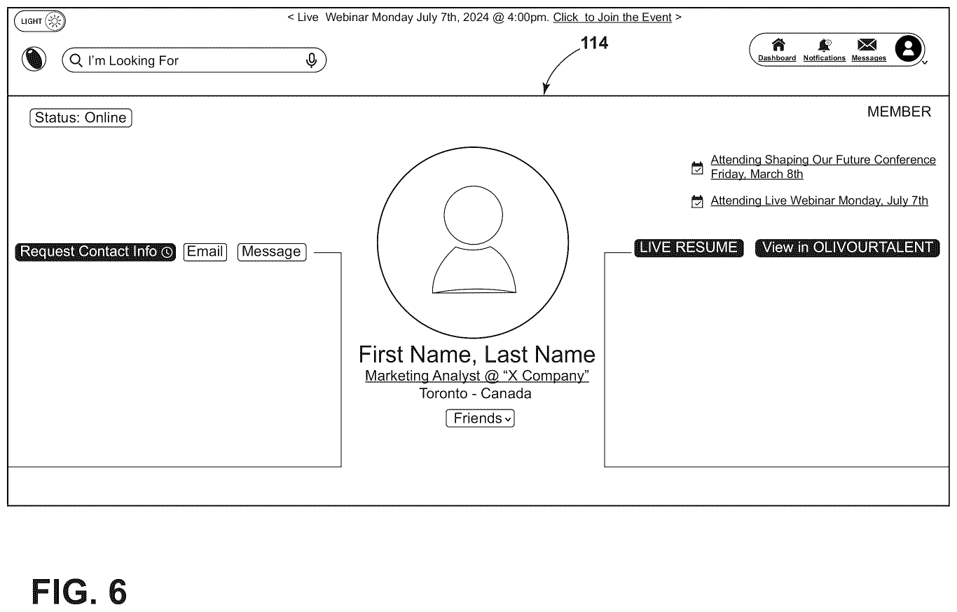

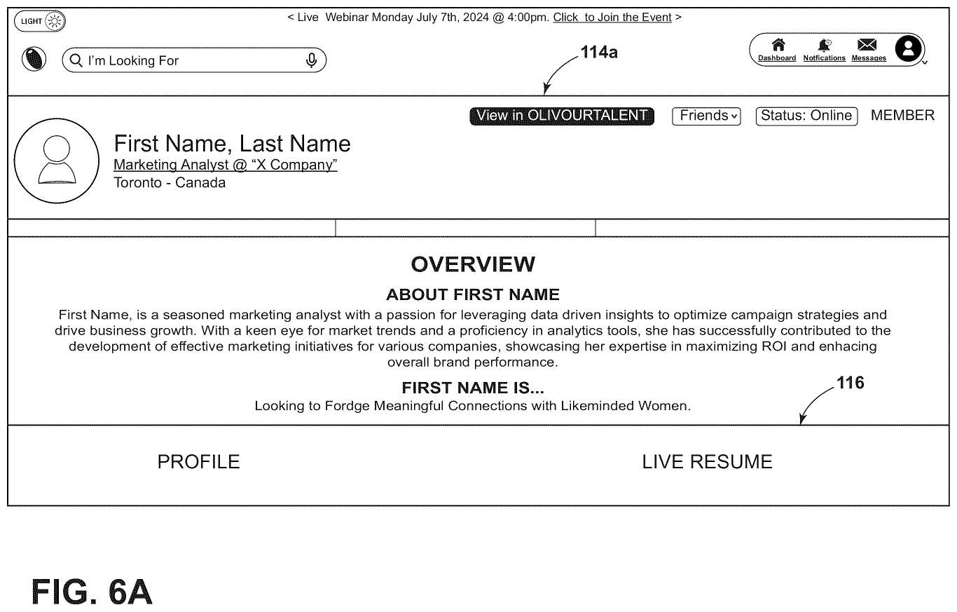

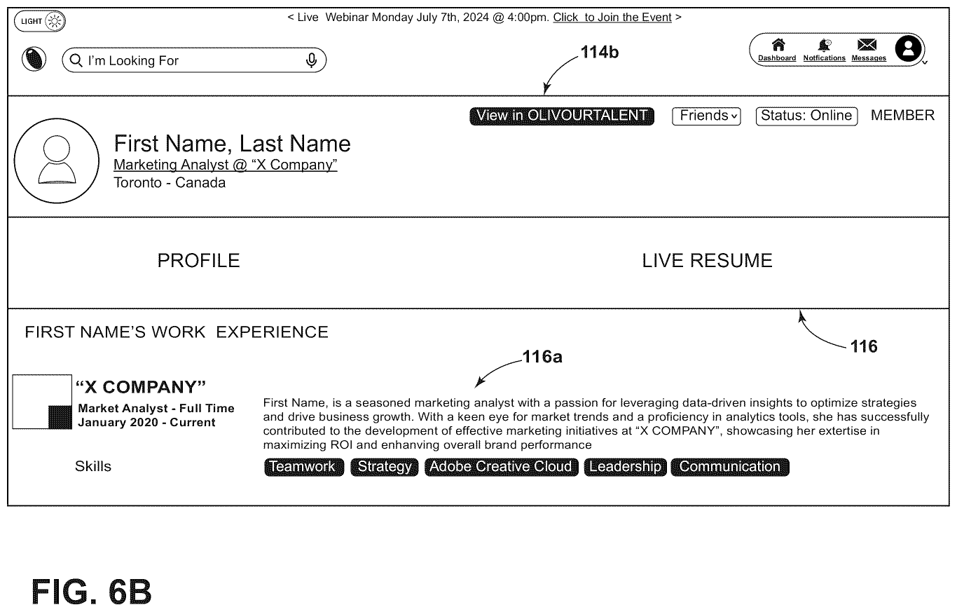

Still referring to FIG. 1B, according to some embodiments of the networking platform 10, the platform can also include a plurality of digital resumes 51, as stored on the server 20. Like the video resume 50, each digital resume 51 can be authored by a user 12 or a candidate 12a (see FIG. 2B). In such embodiments, the user 12 or candidate 12a can employ the digital resume 51 as a supplement to the video resume 50. The digital resume 51 can be a conventional resume, curriculum vitae, user profile (see FIGS. 6-6B, and description later in this disclosure) or the like comprising searchable content 60, e.g., text, and saved in a digital format (e.g., *.txt, *.doc, *.pdf, etc.). In some implementations, the digital resume 51 merely constitutes limited textual information provided by the user 12 or candidate 12a in a user profile created in a user profile portal 114 (see FIGS. 6-6B). Further, each digital resume 51 created by a user 12 or candidate 12a (see FIG. 2B) is tagged by the host networking software for correlation to a video resume 50 created by the same user 12 or candidate 12a. Further, according to some embodiments, the host networking software 100 can be configured such that one or more of the users 12 can evaluate each of the plurality of video resumes 50, along with any corresponding digital resumes 51, based at least in part on the searchable content 60 of the video resumes 50, digital resume 51, e.g., when a user 12 engages in an evaluation process 22 and/or 22a.

Referring now to FIGS. 2-2B, a schematic is provided of a video-assisted networking platform 10 for networking or recruiting functions by candidates 12a and recruiters 12b, each with accounts 10a on the platform 10. The networking platform 10 depicted in FIGS. 2-2B is similar to the platform 10 depicted in FIGS. 1-1B, with like-numbered elements having the same or substantially the same structure and functions. As depicted in FIG. 2, the platform 10 includes: a host network platform server 20; a host networking platform software 100 installed on the server 20 and configured for access by each of the candidates 12a and recruiters 12b; and a plurality of video resumes 50 stored on the server 20. In some embodiments, the host networking platform software 100 is installed on the server 20 according to an installation process 11 (see also FIG. 2A), which can be conducted according to any software storage process understood by those skilled in the field of the disclosure. In some embodiments, the video resumes 50 are stored on the server 20 according to a storing process 21a, initiated by a candidate 12a or the software 100 (see also FIGS. 2A and 2B).

Referring again to FIGS. 2-2B, candidates 12a and recruiters 12b with accounts 10a on the video-assisted networking platform 10 can access its host networking platform software 100 using any of a variety of devices. These devices can include one or more of mobile phone devices 13, desktop computers 14, laptop computers 15, and any other devices or systems capable of running the networking platform software 100 or otherwise interfacing with software 100, as installed on the server 20. Moreover, as is evident from FIG. 2, various candidates 12a and recruiters 12b may interact with the platform 10 at the same time or at different times by use of their respective accounts 10a on the host networking platform software 100, e.g., as installed on the host network platform server 20.

Referring again to FIGS. 2-2B, each video resume 50 of the video-assisted networking platform 10, e.g., as stored on the server 20, is authored by one of the candidates 12a. Further, each video resume 50 comprises searchable user-authored content 60 in a video resume format 70 specified by the platform software 100. In some embodiments, the searchable user-authored content 60 of the video resume 50 authored by a candidate 12a comprises textual content 62. The host networking platform software 100 is configured such that each video resume 50 can be generated and modified by one of the candidates 12a. In some embodiments, each video resume 50 is generated and/or modified by one of the candidates 12a by use of the software 100 according to a video resume creation process 21 (see FIG. 2A, as described further below), e.g., with the software 100 prompting the candidate 12a in the creation of one or more video files that correspond to the prescribed video resume format 70. For example, the prescribed video resume format 70 of the software 100 can guide the candidate 12a in the creation of various video files that make up the video resume 50, each such file corresponding to the candidate's 12a work statement, experience, skills, interests, education, etc.

Referring again to FIGS. 2-2B, the host networking platform software 100 of the networking platform 10, according to some embodiments, can be configured with a conversion component 66 that is capable of converting some or all of the raw user-authored video content 61 into the searchable user-authored content 60, e.g., by adding metadata, temporal components or other searchable material to such raw video content during or after creation by the candidate 12a. Further, in some implementations, the searchable content 60 includes processed video content 61a, as derived from raw user-authored video content 61. According to some embodiments, the searchable content 60 of a video resume 50 can include raw user-authored video content 61 and/or processed video content 61a, each content type capable of being searched based on their temporal components, substantive components (e.g., work history discussion, education discussion, skills discussion, etc.), metadata and/or as converted by the software 100 or other algorithm into a searchable form (e.g., video-to-text transcription).

Still referring to FIGS. 2-2B, the host networking platform software 100 can be further configured such that the textual content 62 of each video resume 50 created by a candidate 12a, as noted earlier, can comprise a plurality of resume topic headings 72. The resume topic headings 72 can be configured to organize the searchable user-authored content 60. Further, according to some embodiments, the resume topic heading 72 can be based on input from one of the recruiters 12b, who is responsible for an open position 18.

Still referring to FIGS. 2-2B, the host networking platform software 100 of the networking platform 10 is configured such that each of the plurality of video resumes 50, e.g., as stored on the server 20, can be authenticated by a candidate 12a. The networking platform 10 of the disclosure also contemplates the use of an authentication process 31 in connection with the authentication aspect of the software 100 (see also FIG. 2A). Further, the networking software 100 can be configured with any of various authentication components, as would be understood by those skilled in the field of the disclosure, suitable for ensuring that a video resume 50 created by a candidate 12a is user-authored and not otherwise created by, altered by or otherwise influenced by a non-authorized user of the networking platform 10, the result of a generative artificial intelligence query, algorithm, or any other non-human video resume creation source, algorithm or scheme. In some embodiments, the host networking platform software 100 is configured such that each of the video resumes 50, as stored on the server 20, can be authenticated by one of the candidates 12a as constituting raw user-authored video content 61 generated in one take (i.e., each raw video content file is generated in a single take without further editing), much as one would deliver during a live interview. Suitable authentication components, approaches, algorithms, widgets and/or add-ons employed by the software 100 include a two-factor authentication scheme for use by the candidate 12a, a passkey provided to the candidate 12a, a QR code that can be scanned by a device owned by the candidate 12a, a fingerprint scanning and recognition scheme, and generative AI or machine learning algorithms configured to detect inauthentic video content within a video resume 50. Any such authentication approaches, according to embodiments, can be activated or effected during set up of an account 10a on the network 10 by a candidate 12a.

Still referring to FIGS. 2-2B, the host networking platform software 100 of the networking platform 10 is configured such that one or more of the recruiters 12a, with an open position 18, can evaluate each of the plurality of video resumes 50 against the open position 18 based at least in part on the searchable user-authored content 60 of each of the video resumes 50. The networking platform 10 of the disclosure also contemplates an evaluation process 22 in connection with the evaluation aspect of the software 100 (see also FIG. 2B, as described in further detail below). The software 100 can be advantageously configured such that a recruiter 12b can evaluate the searchable content 60 (e.g., textual content 62, raw user-authored video content 61, processed video content 61a, etc.) of the plurality of video resumes 50 to engage in recruiting for an open position 18 and further contact with the candidate(s) 12a that authored one or more video resumes 50 of interest.

Referring now to FIG. 2A, a schematic of the host networking software 100 of the networking platform 10 is provided, as employed by candidates 12a to generate video resumes 50 stored on the server 20 of the platform 10. As shown, each video resume 50 can be generated and/or modified by one of the candidates 12a by use of the software 100 according to a video resume creation process 21. Further, each video resume 50 includes user-authored searchable content 60 in a video resume format 70, as specified by the software 100 and/or by the recruiter 12b based on an open position 18. For example, the software 100, e.g., as based on input from a recruiter 12b, can prompt the candidate 12a in the creation of one or more video files (e.g., *.mov files) that correspond to the prescribed video resume format 70. In some embodiments, the prompts or sets of questions provided by the software 100 (e.g., based on input from the recruiter 12b) are available to the candidate 12a only at the time the candidate 12a begins recording the video resume 50, e.g., to drive authenticity in the creation of the content of the video resume 50. In other embodiments, the prompts or sets of questions provided by the software 100 (e.g., based on input from the recruiter 12b) are varied for each candidate 12a on a random basis or according to a prescribed pattern (e.g., with 3-4 versions), e.g., to drive authenticity in the creation of an authentic, video resume 50. The searchable content 60, as shown, can also include textual content 62 (e.g., metadata, resume headings, etc.) and, in some embodiments, the textual content 62 can include resume headings 72 (e.g., statement, education, work experience, and interests). In some embodiments, the resume headings 72 can be based on input from a recruiter 12b, according to a resume heading input process 42 (see FIG. 2B). In some implementations, the searchable content 60 can include textual content 62 and processed video content 61a (e.g., *.mov files). The textual content 62 can also include processed textual passages 62a, derived from raw user-authored video content 61.

Referring now to FIG. 2B, a schematic of the host networking software 100 of the networking platform 10 is provided, as employed by recruiters 12b to evaluate video resumes 50, as stored on the server 20 of the platform 10. As shown, the host networking platform software 100 of the networking platform 10 is configured such that one or more of the recruiters 12b can evaluate each of the plurality of video resumes 50 based at least in part on the searchable user-authored content 60 of each of the video resumes 50 against an open position 18. The networking platform 10 of the disclosure also contemplates an evaluation process 22, as shown, in connection with the evaluation aspect of the software 100. In particular, the networking software 100 can be configured with any of various searching components, approaches, algorithms, widgets and/or add-ons, as would be understood by those skilled in the field of the disclosure, suitable for evaluating and searching the searchable content 60 of a plurality of video resumes 50, as derived from the raw user-authored video content 61. As also shown in FIG. 2B, the networking platform 10 of the disclosure also contemplates the use of an evaluation process 22a in connection with a machine learning component aspect of the software 100. The machine learning component 80 can be any generative AI or AI-driven add-on capable of reviewing raw user-authored video content 61 against a user-provided criterion or query, such as a communication-oriented criterion 82. That is, in some implementations, the recruiter 12b can evaluate the searchable content 60 of the video resumes 50 that comprises or consists of raw video content 61, e.g., to assess the communication skills of a candidate 12a against some criterion, e.g., particular communication-related skills, language fluency, body language, and other behaviors etc., as based on the open position 18.

Still referring to FIG. 2B, according to some embodiments of the networking platform 10, the platform can also include a plurality of digital resumes 51, as stored on the server 20. Like the video resume 50, each digital resume 51 can be authored by a candidate 12a. In such embodiments, the candidate 12a can employ the digital resume 51 as a supplement to the video resume 50. The digital resume 51 can be a conventional resume, curriculum vitae, user profile (see FIGS. 6-6B, and description later in this disclosure) or the like comprising searchable content 60, e.g., text, and saved in a digital format (e.g., *.txt, *.doc, *.pdf, etc.). In some implementations, the digital resume 51 merely constitutes limited textual information provided by the candidate 12a in a user profile created in a user profile portal 114 (see FIGS. 6-6B). Further, each digital resume 51 created by a candidate 12a is tagged by the host networking software for correlation to a video resume 50 created by the same candidate 12a. Further, according to some embodiments, the host networking software 100 can be configured such that one or more of the recruiters 12b can evaluate each of the plurality of video resumes 50, along with any corresponding digital resumes 51, based at least in part on the searchable content 60 of the video resumes 50, digital resume 51 against the open position 18, e.g., when a recruiter 12b engages in an evaluation process 22 and/or 22a.

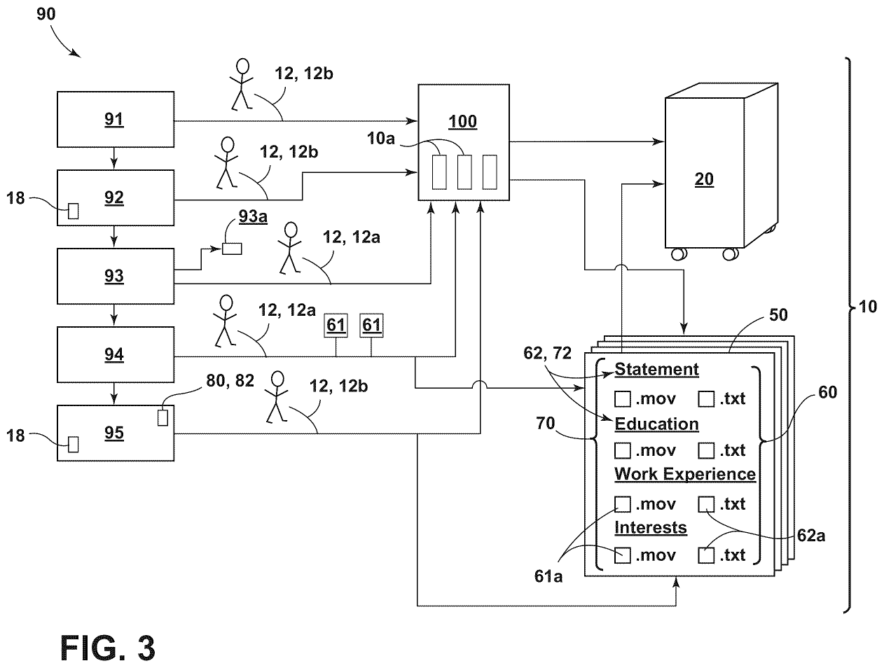

Referring now to FIG. 3, a schematic flow chart is provided of a method of networking 90, which can employ the video-assisted platform 10. The method of networking 90 includes the following steps: a step 91 of accessing the networking platform (e.g., platform 10, as shown in FIGS. 1-1B and 2-2B and described above) by use of one of the accounts 10a of the users 12 or recruiters 12b on the platform; and a step 92 of designating a video resume format 70 on the host networking platform software 100 based at least in part on an open position 18, the step 92 of designating conducted during the step 91 of accessing the networking platform 10 by use of one of the accounts 10a of the recruiters 12b.

Referring again to FIG. 3, the method of networking 90 further includes the following steps: a step 93 of accessing the networking platform 10 by use of one of the accounts 10a of the candidates 12a (or by a user 12); a step 94 of recording a video resume 50 using the host networking platform software 100 for storage on the host network platform server 20, the step 94 of recording conducted during the step 93 of accessing the networking platform 10 by use of one of the accounts 10a of the candidates 12a (or users 12); a step 95 of evaluating the video resume 50 against the open position 18 using the host networking software 100 and by the step 91 of accessing the networking platform 10 by use of the one of the accounts 10a of the recruiters 12b (or a user 12); and a step 93a of authenticating the video resume 50 using the host networking platform software 100. Further, the step 93a of authenticating is conducted during the step 91 of accessing the networking platform 10 by use of one of the accounts 10a of the candidate 12a (or a user 12). In some embodiments, the step 93a of authenticating can be further conducted such that the raw user-authored content 61 is generated in one take. In addition, the step 92 of designating the video resume format 70 is conducted before the step 94 of recording the video resume 50. Further, as detailed earlier, the video resume 50 comprises searchable user-authored content 60 derived from raw user-authored video content 61 in a video resume format 70 provided by the host networking platform software 100. In addition, the step 95 of evaluating is conducted based at least in part on the searchable user-authored content 60 of the video resume 50.

According to some implementations of the method 90 depicted in exemplary form in FIG. 3, the step 92 of designating a video resume format 70 is conducted by use of one of the accounts 10a of a user 12 and is not necessarily based on an open position 18. For example, in such embodiments, a user 12 may select the video resume format 70 to be used by the host networking software 100, e.g., for networking purposes. In other embodiments, the video resume format 70 can be set during the step 92 of designating by a user 12 as a default setting of the host networking software 100 to ensure that a common resume format 70 is utilized by some or all users 12 according to the method of networking 90.

With further reference to the method 90 of networking depicted in exemplary form in FIG. 3, according to some embodiments, users 12 (including candidates 12a) can engage in the steps 93 and 94 to access the networking platform 10 and record video resumes 50, respectively, e.g., for purposes of networking, job-seeking, and other related functions. In some embodiments of the method 90, a user 12 or candidate 12a will be required to create a video resume 50 according to steps 93 and 94 within a specified time frame (e.g., 30, 60 or 90 days) from obtaining an account 10a on the networking platform 10 or from the time in which the user 12 or candidate 12a has created a user profile (e.g., digital resume 51) within the user profile portal 114 (see FIGS. 6-6B, and description below). If a user 12 or candidate 12a, according to these embodiments, fails to create a video resume 50 within the specified time, the user 12 or candidate 12a may lose access to the account 10a. Ultimately, these embodiments are believed to provide an added measure of authenticity in the creation of the video resumes 50 on the networking platform 10, as users 12 and candidates 12a must create video resumes 50 in a timely manner as it is a principal aspect of the networking platform 10.

According to some embodiments of the method 90, as depicted in FIG. 3, users 12 (including recruiters 12b) can engage in the step 95 of evaluating a video resume 50 based at least in part on the searchable content 60 of the video resume 50 for purposes of networking, job-seeking, and other related functions. According to some embodiments, the step 95 of evaluating the video resume 50 against an open position 18 can further include evaluating the raw user-authored video content 61 of the video resume 50 with a machine learning component 80 of the host networking software 100 against a communication-oriented criterion 82, as detailed earlier in the disclosure. Such an evaluation according to the method 90 can be conducted by a recruiter 12b. However, according to some embodiments of the method 90, such an evaluation according to step 95 with a machine learning component 80 can also be conducted by users 12, e.g., as motivated by networking and related purposes, and not necessarily recruiting for an open position.

Referring now to FIG. 4, a schematic is provided of the host networking platform software 100 of the video-assisted networking platform 10 (see FIGS. 1-1B and 2-2B). FIG. 4 depicts, according to some embodiments, how the platform software 100 may be accessed through a central dashboard 112. After a login 102 by a user 12, candidate 12a, and/or recruiter 12b, the central dashboard 112 enables access to various functions provided by the network 10. individual making use of the services and inventive elements provided by the platform.

Referring again to FIG. 4, the central dashboard 112 of the host networking platform software 100 can include various portals. According to an exemplary embodiment, as depicted in FIG. 4, the central dashboard 112 includes the following portals: a user profile portal 114, live resume portal 116, my jobs portal 118, jobs portal 120, calendar portal 122, live feed portal 124, my network portal 126, career resources portal 128, community forum portal 130, group portal 132, event portal 134, info session portal 136, mentor's portal 138, and newsletter portal 140.

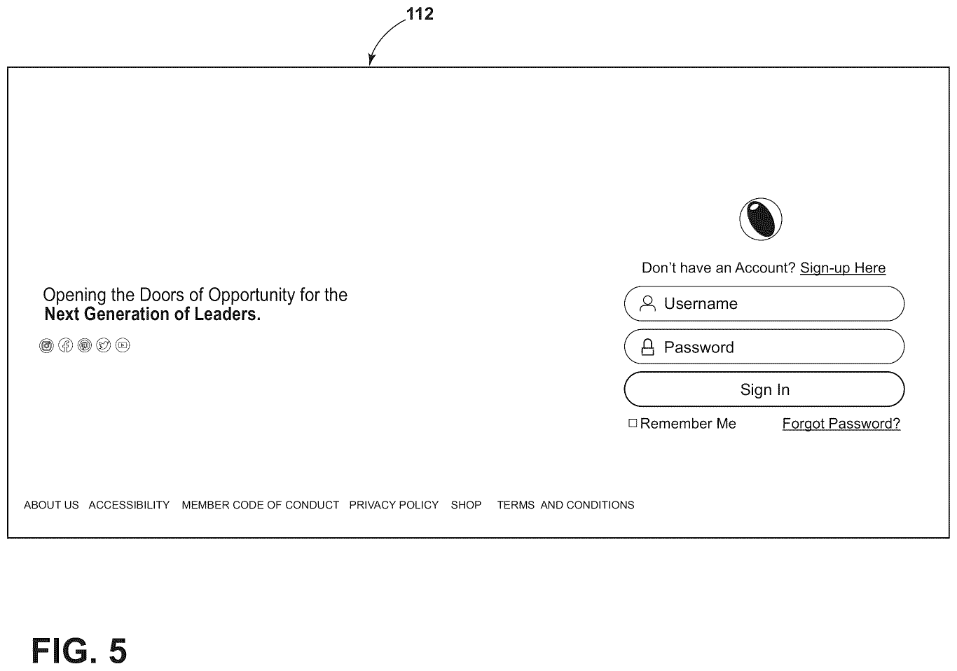

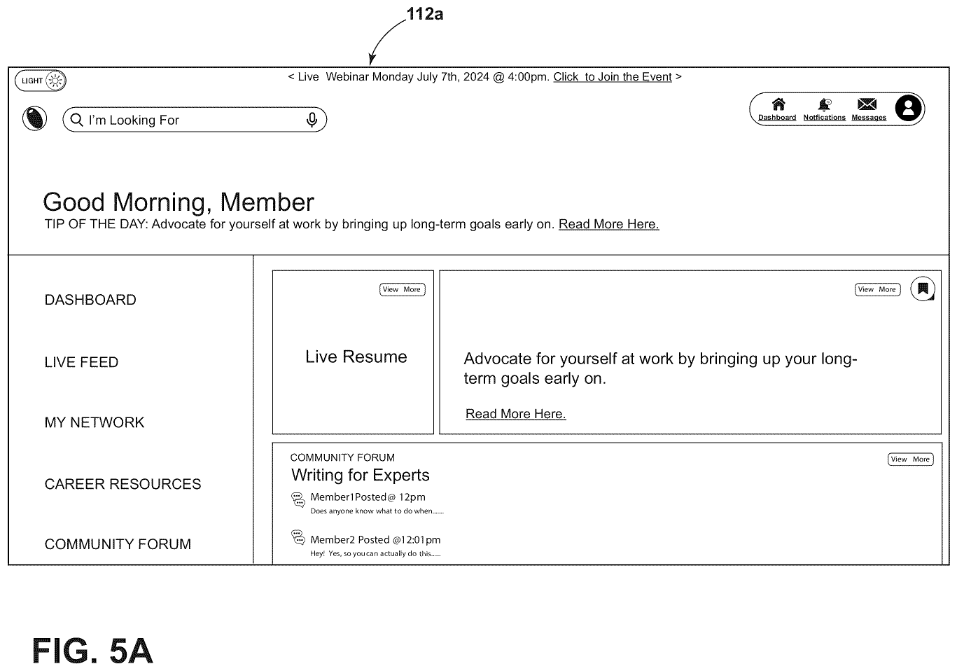

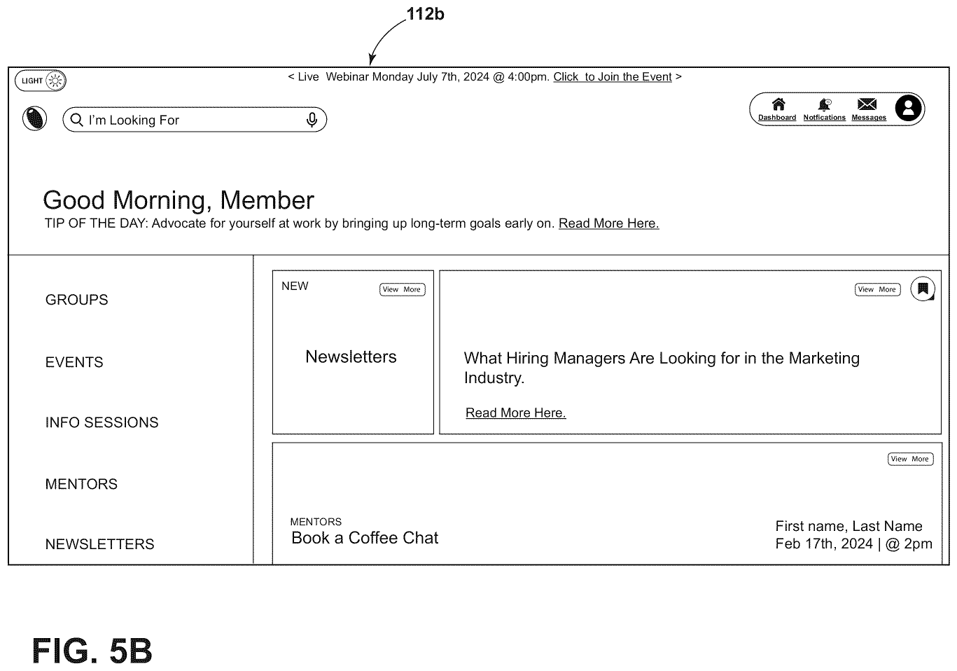

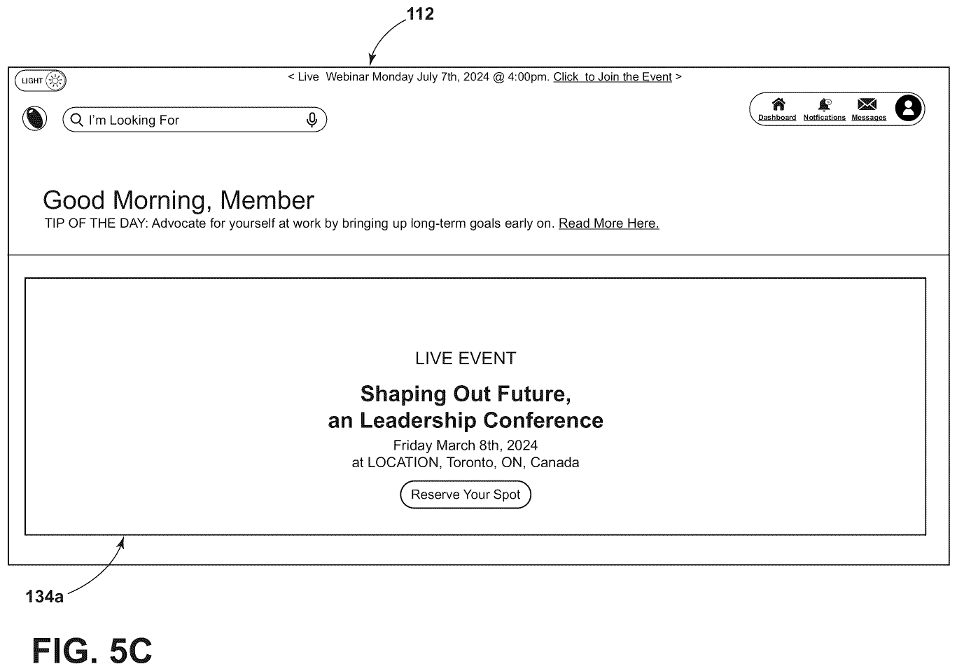

Referring now to FIG. 5, a webpage is provided of the central dashboard 112 of the networking platform software 100. The central dashboard 112 is represented in FIG. 5 as a web page of the video-assisted networking platform 10 that serves as a login portal to each of the various functions provided by the platform 10. The central dashboard 112 enables a user 12 (including candidates 12a and recruiters 12b) to access an account 10a on the networking platform 10 and access notifications, send messages, in addition to monitoring updated content provided by other parties and updating the user profile portal 114. For example, a computer cursor may be dragged over an icon or button included in the central dashboard 112 to access a desired function in a known manner.

Referring again to FIG. 5, the user 12 (e.g., candidate 12a, recruiter 12b) may customize the central dashboard 112 to suit individual preferences. Color, font, and representations may all be revised. The central dashboard 112 may be modified to link to desired portals within the platform (see FIG. 4). For example, a direct link to the live resume portal 116, community forum portal 130, career resources portal 128, etc., may be included in the central dashboard 112 either by preference or based upon frequency of use of any of these web pages. For example, FIGS. 5A and 5B each show a webpage of an alternative central dashboard 112a, 112b of the networking software 100. As another example, FIG. 5C shows a webpage of the central dashboard 112 of the networking platform software 100 with a networking invitation 134a, as generated through the event portal 134 and/or my network portal 126.

According to embodiments of the host networking platform software 100, as shown in FIGS. 4 and 5, it is contemplated that the user 12 is provided access to individual central dashboards 112 to provide, for example, tip of the day, updates, live event announcements and other public service content. A user 12 may select which of these features are included within the dashboard 112. A central menu bar provides a user 12 with access to any of these portals to obtain information being provided. Drop down menus and scrolling features enable a user 12 to rapidly identify what content has been included since the last time a user 12 accessed the networking platform 10. It should be further understood that notifications not seen since the last time the platform 10 was accessed, are displayed as pop-up or dropdown windows.

Referring now to FIG. 6, a web page of the user profile portal 114 is shown, as accessed through the central dashboard 112 of the host networking platform software 100 of the video-assisted networking platform 10. A user 12 (e.g., candidate 12a, or recruiter 12b) or a user profile may be accessed through the user profile portal 114. The user profile portal 114 enables the user 12 to generate and update a digital resume (e.g., digital resume 51) that includes, for example, work experience, interests, skills, biographies, etc. The digital resume 51 can be used with the recruitment function of the networking platform 10 of the present disclosure, as described earlier and further below.

Referring again to FIG. 6, in some embodiments, the user profile portal 114 is a digital version of a resume, curriculum vitae or profile of a user 12 or candidate 12a. The user profile portal 114 is selectively publicly available or private as desired by the user 12 or candidate 12a. In some implementations, the elements within the user profile portal 114 can be as follows: (a) ability to list whether the user is online, offline, busy, etc.; (b) the ability to list any events a user is attending; and (c) a distinction badge for the user 12 (e.g., between candidate 12a and recruiter 12b). The distinction badge is relevant to the recruitment aspects of the networking platform 10, as the badge can ensure that all users 12, particularly candidates 12a and recruiters 12b, properly safeguard user information (some of which a user 12 may wish to be confidential only allowing access to other users 12 of the platform 10), and to signify that recruiters 12b and/or their companies have been vetted before receiving access to the networking platform 10. For example, if the user 12 is a recruiter 12b, the individual will have a recruiter tag at the top right-hand corner of the webpage of the user profile portal 114. A recruiter 12b may also obtain a license from the host or owner of the video-assisted networking platform 10 to provide access, or enhanced access to a user profile portal 114 of a given user 12 or candidate 12a. Recruiters 12b will be able to request contact information for the user 12 or candidate 12a. Users 12 and/or candidates 12a may optionally show their contact information on their user profile portal 114 enabling unregistered recruiters 12b to make individual contact with them.

Referring now to FIGS. 6A and 6B, webpages of alternative user profile portals 114a, 114b are provided with a live resume portal 116 button and an employment listing/work experience button 116a, respectively. All information listed in the user profile portal 114 is created via a form that users 12 or candidates 12a can edit directly on the site and enter in the following information as required. As shown in FIGS. 6A and 6b, two tabs can be provided for access to either the profile or live resume (i.e., video resume 50) of the user 12. Under the profile button, a user 12 or recruiter 12b will find the experience, posts, activity log, etc. of the candidate 12a. A profile of a user 12 includes key searchable terms that indicate profession or employment intent. As shown in FIG. 6B, the work experience button 116a of a user 12 can be required for entry by the networking platform 10 and host platform networking software 100, including roles and responsibilities for each work experience entry, as well as relevant skills to that job, dates, and titles.

Referring again to FIGS. 6A and 6B, listed under the profile tab or button of the alternative user profile portals 114a, 114b are the relevant interests, general skillsets, education, certifications, as well as other pertinent information of the user 12 or candidate 12a. The live resume portal 116 (shown as a button or tab) will work more like a button and is optionally only accessible to recruiters 12b. Users 12 or candidates 12a will also be able to give permission for other users 12 or recruiters 12b to view their live resume (i.e., video resume 50). Once a user 12 or candidate 12a applies to an open position (e.g., open position 18 detailed earlier), a recruiter 12b affiliated with that position 18 is provided access to the profile of the user 12 or candidate 12a automatically even when the profile is otherwise designated as private.

In some embodiments of the video-assisted networking platform 10, as shown in FIG. 4, a video resume 50 (see FIGS. 1-2B) can be generated through accessing the live resume portal 116 for the purpose of supplementing the digital resume 51 and providing more intimate insight into a user 12 or candidate 12a than is possible by a digital resume 51 alone. The live resume (i.e., a video resume 50) is recorded using any digital video device including a computer camera and allows the user 12 or candidate 12a to show individual characteristics not available through text alone. The video resume 50 is a recorded video version of the resume of the user 12 or candidate 12a that may be updated on an as needed basis. It is believed that providing the video resume 50 enables a potential employer (e.g., a recruiter 12b) to determine suitability of a candidate 12a more accurately for a position (e.g., an open position 18 associated with the recruiter 12b). In one embodiment, the video resume 50 is time-limited from the time it is posted on the networking platform 10 to ensure that any outdated information is not maintained on the platform 10. In an embodiment, the host networking platform software 100 prompts a candidate 12a or user 12 periodically to provide updates to the video resume 50 stored in the server 20 of the networking platform 10. An advantage of the networking platform 10, and particularly the use of the video resumes 50, is that it can give recruiters 12b a first interview of a candidate 12a during an early recruitment phase, well before the time and cost of conducting in-person live interviews with a candidate 12a.

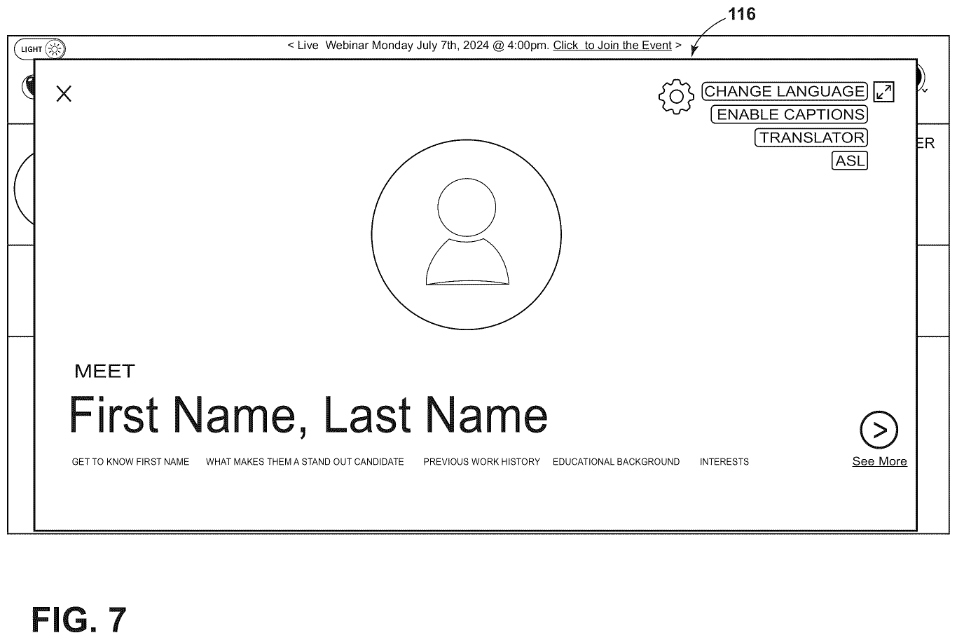

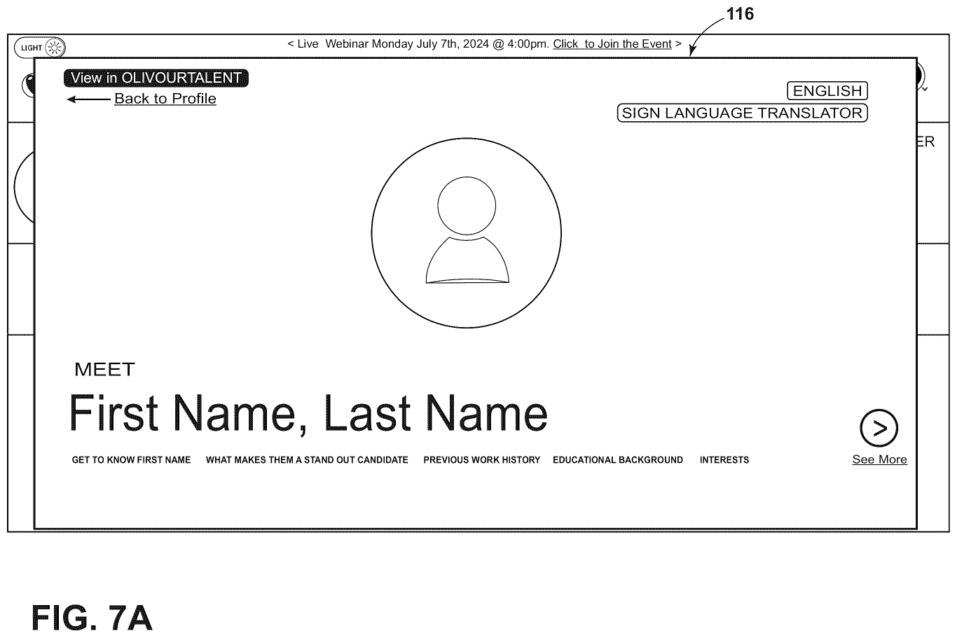

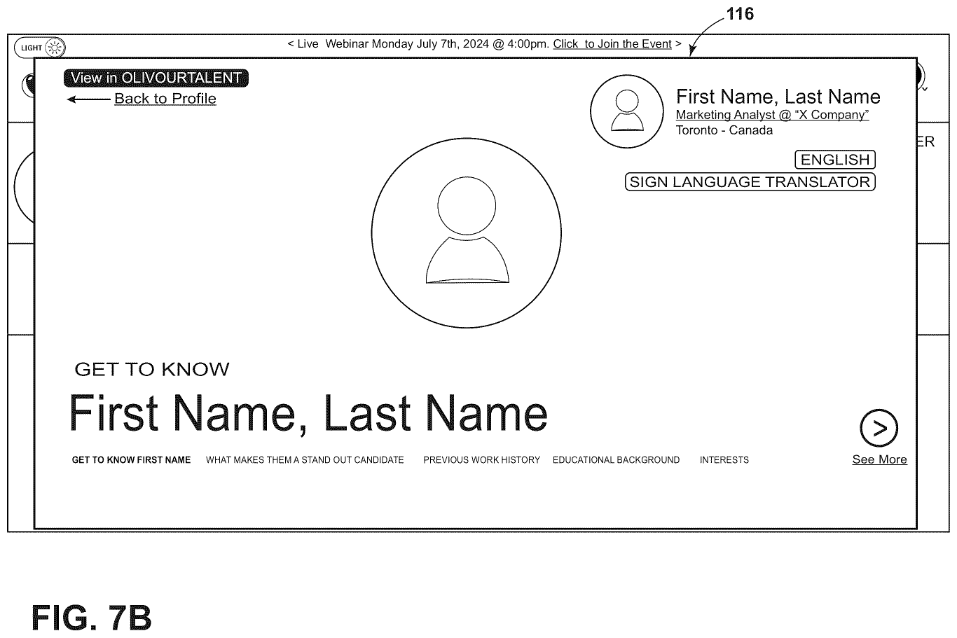

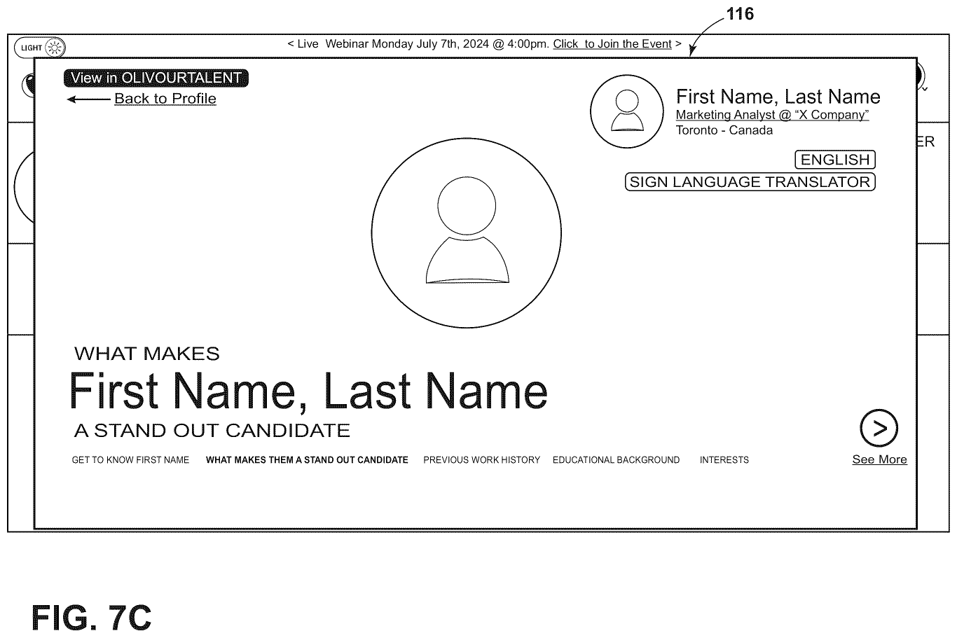

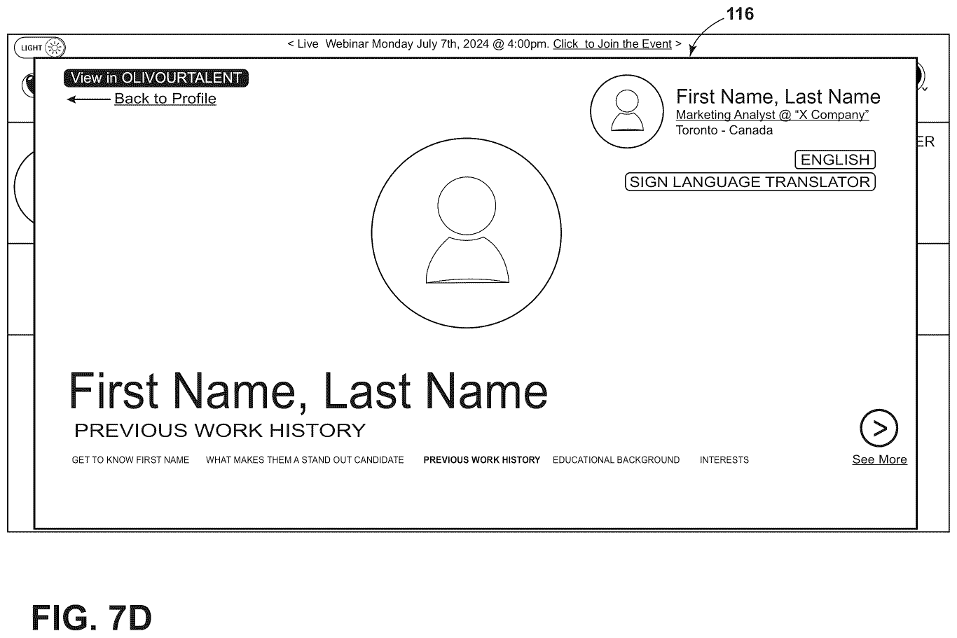

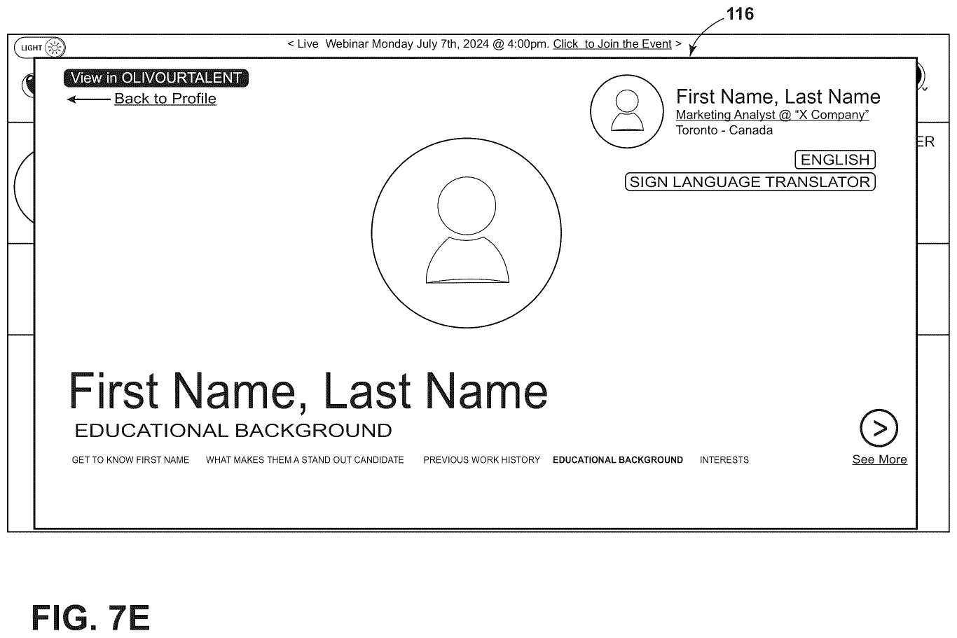

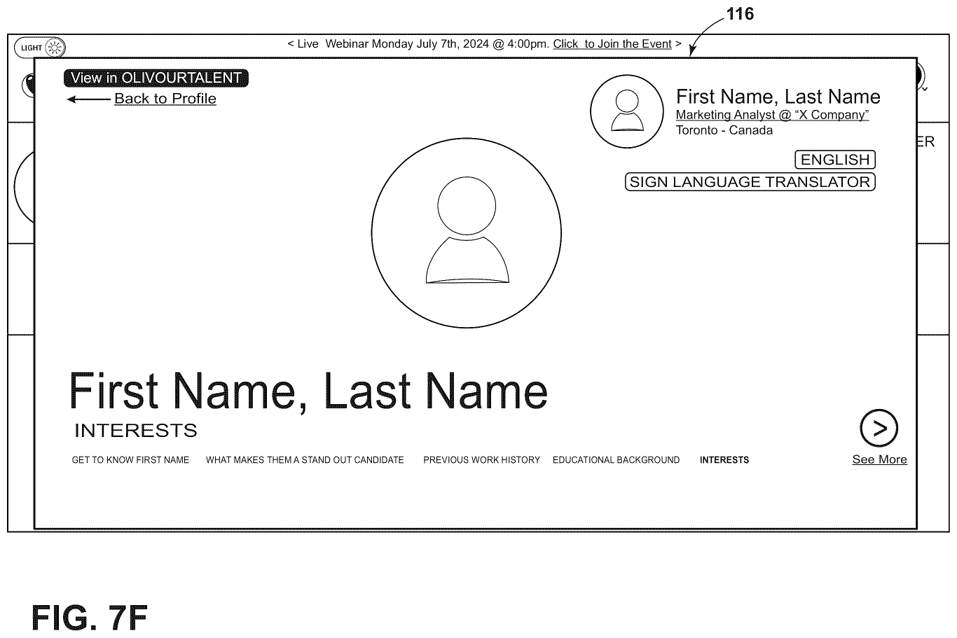

Referring now to FIG. 7, a webpage is provided of the live resume portal 116 of the central dashboard 112 of the host networking platform software 100. It should be obvious to those of ordinary skill in the art that use of the video resume 50 by the video-assisted networking platform 10 of the disclosure advantageously utilizes video imaging to streamline recruitment and networking. The live resume portal 116 changes the way individuals (i.e., users 12, candidates 12a and recruiters 12b) within the global workforce can connect, meet, network, and recruit. The live resume concept, as embodied in the live resume portal 116 and video resumes 50, improves efficiency for recruiters 12b by allowing recruiters 12b to gain knowledge of a candidate's 12a oral qualities prior to the interview stage, decrease full reliance on reading written applications and conventional text resumes, etc. In an analogous manner candidates 12a may now enhance the display and communication of their qualifications by preparing verbal and visual content that provides a more fulsome picture of their qualifications, goals, etc.

Referring again to FIG. 7, the live resume portal 116 further improves communication strategies by including live content elements. Therefore, meetings, scheduling and calling may all be performed through the live resume portal 116 without having to leave the video-assisted networking platform 10 and schedule a meeting on an alternative internet application. Real-time meetings with a user 12 who may speak a different language is also enabled through real-time translation of communications whether recorded or live. Translations are provided in audio and/or textual form. It is believed that, for the first time, interviews may be conducted in foreign languages on the networking platform 10 of this disclosure (e.g., by close captioning during the meetings, as provided by the transcription component of the live resume portal 116), without requiring the use of multiple communication applications and technology, or without the use of a live translator. Thus, multilingual navigation that translates written text and audio text to a user-specified language is readable and in the language of choice. Audio video content that assists a user 12 with limited literacy skills is also generated in real time to improve communication between users 12 having different language backgrounds.

Once clicked (e.g., in the central dashboard 112 shown in FIG. 4), the live resume portal 116 will pop-up on the screen, e.g., as shown in FIG. 7. It should be understood that various video content associated with video resume 50 of a candidate 12a or user 12 is embedded within the live resume portal 116. Various methods of use of the live resume portal 116 are explained below. Like the central dashboard 112, names are automatically generated into the following text as demonstrated, based off of the profile information entered by a given user 12. As an initial matter, as shown in FIG. 7A, the live resume portal 116 can be provided with a sign language button. The networking platform 10 can translate voice and written text to American Sign Language (ASL) and ASL to written and auditory mediums. Further translation from foreign languages is simultaneously achieved with conversion from voice to written text. Time delays and speed adjustments may be personalized by a user 12. Also, tactile notices are provided for users 12 who are hearing impaired (not shown). For users 12 that are hearing impaired, implementation of close captioning of the live resume portal 116 and/or its video resumes 50 can be provided. Therefore, multiple navigation options can be provided within the live resume portal 116 of the networking platform 10 for all users 12, inclusive of users 12, candidates 12a and recruiters 12b with different hearing, visual and language capabilities.

Referring now to FIGS. 7A and 7B, the live resume portal 116 can be provided as an interface for a recruiter 12b showing various video content information of a given candidate 12a or user 12. Similarly, as shown in FIG. 7C, the live resume portal 116 can provide an interface for a recruiter 12b showing other video content information of a given candidate 12a or user 12. For example, as shown in FIGS. 7A and 7B, the live resume portal 116 can provide a recruiter 12b with separate video content from the video resume 50 of a candidate 12a to “meet” and “get to know” the candidate, respectively. As another example, as shown in FIG. 7C, the live resume portal 116 can provide a recruiter 12b with separate video content from the video resume 50 of a candidate 12a highlighting what makes the particular candidate “stand out”.

Referring again to FIGS. 7A-7C, as the recruiter 12b scrolls through the webpage of the live resume portal 116, a video associated with the video resume 50 of the candidate 12a is prompted to start (with basic pause/play, fast-forward, volume capabilities). Recruiters 12b are able to click on specific parts of the video resume 50 via the bottom menu bar. For example, as shown in FIGS. 7D-7F, webpages of the live resume portal 116 are provided that correspond with a user's (e.g., a candidate 12a) previous work history, educational background, and interests, respectively. Buttons that correspond to these aspects of the video resume 50 of the user 12 or candidate 12a are shown in the bottom of the live resume portal 116, as depicted in FIGS. 7D-7F.

Referring again to FIGS. 7-7F, the live resume portal 116 can include content stamps that are identifiable with digital buttons or icons that enable recruiters 12b to advance the live resume (i.e., video resume 50) to desirable content, such as, for example an explanation of work history or hobbies. This allows the recruiter 12b to focus more on the candidate 12a by seeking recorded answers to standard interview questions or common interview questions. In some embodiments, the live resume portal 116 (not shown) will also include a link to a network portal 126 (see FIG. 4) where the recruiter 12b can go directly to a recruitment webpage to view the candidate's 12a information, add them to pipelines, organizational charts, etc., to create an employment network for further analysis by the recruiter 12b.

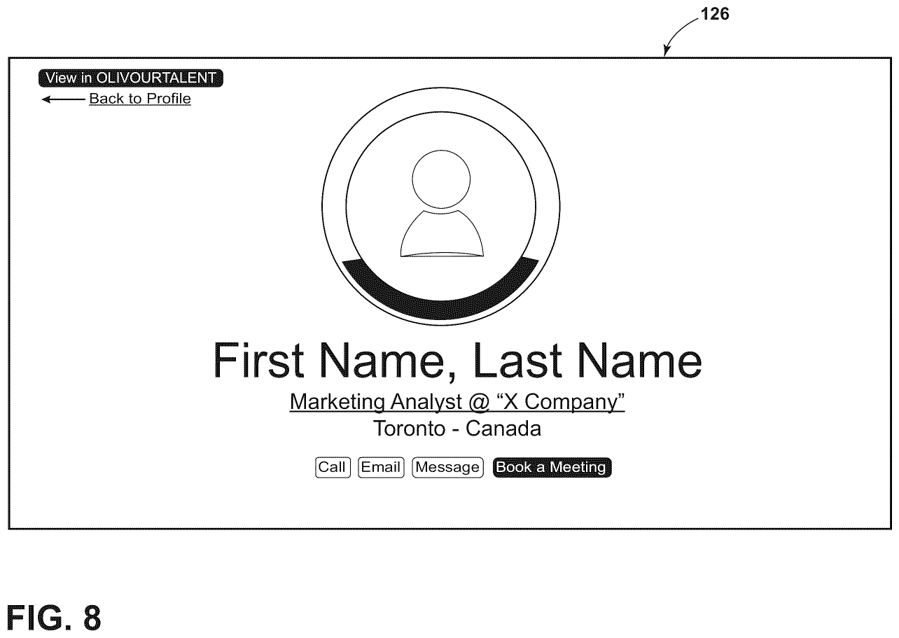

After evaluating a user 12 or candidate 12a using the live resume portal 116, as depicted in FIGS. 7-7F, a recruiter 12b may directly book a meeting, or contact a candidate 12a or user 12 by way of pop-up button or icon. For example, as shown in FIG. 8, a webpage is provided of the networking portal 126 of the central dashboard 112 (see FIG. 4), as configured with communication buttons for directly contacting a user 12 or candidate 12a. A meeting can then be scheduled via the video-assisted network platform 10 and, particularly, its central meeting functionality. Further, according to some embodiments, the networking portal 126 can include a calendar to set meeting times and send invitations, booking features, audio, and video.

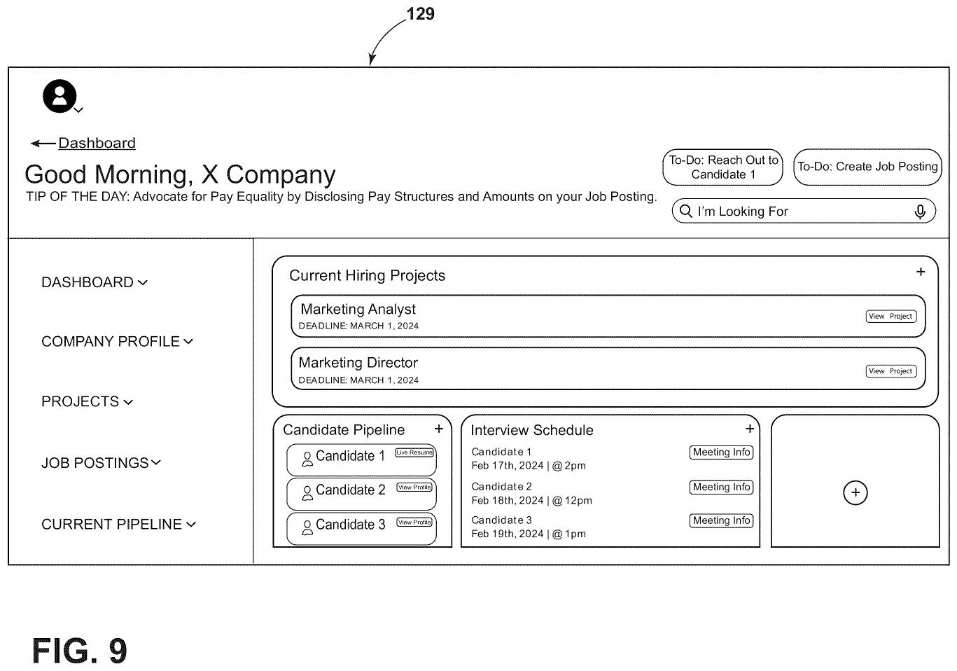

Referring now to FIG. 9, according to an embodiment, a webpage is provided of a company specific dashboard 129 of the central dashboard 112 (not shown in FIG. 4). As shown, a recruiter 12b is provided with an alternative dashboard to a user 12 (or candidate 12a) who is merely networking or seeking employment. For example, like the central dashboard 112 (see FIG. 4), the company specific dashboard 129 allows for the customization of names, as well as the ability for the recruiter 12b to enter company centric central dashboard items (e.g., “Tip of the Day”, a glance of their candidate pipeline to date, hiring projects, interview schedule, etc.). This provides the ability for a company (as represented by a recruiter 12b) to use the networking platform 10 as a daily internal communications platform. In addition, the recruiter 12b may use the platform 10 as a central method for hiring in innovated ways as compared to traditional recruiting methods. A task list of reminders may be independently located at the top of a company specific dashboard 129.

As evidenced by the foregoing functionality and capabilities of the host networking platform software 100, the video-assisted networking platform 10 of the disclosure improves current recruitment/job application processes by providing comprehensive filtering capabilities by providing more detailed search filters than presently available in conventional networking platforms. In some embodiments, the software 100 is configured with a search bar that allows for completely customizable search tools and features. As an example, rather than relying solely on a word bank or key terms uploaded for use, the user 12 or recruiter 12b can supplement an available word bank and utilize their own key terms and phrases to find other users 12 or candidates 12a on the platform.

This enhanced search capability enables recruiters 12b to be as specific as required for the role (e.g., open position 18) in which they are hiring. Recruiters 12b are able to view their pool of candidates 12a strictly via their video resumes 50 or via their profile (e.g., digital resume 51) coupled to their video resume 50 within the live resume portal 116. The profile enables a recruiter 12b to request additional information from a candidate 12a, if additional information with regards to the candidate's work experience is required prior to scheduling a meeting or if a downloadable copy of the candidate's video resume 50 (as transcribed by the software 100) and/or a digital resume 51 is required for recruitment/onboarding processes. Recruiters 12b are able to completely customize their company profile, update/create projects for hiring, update/post job postings (e.g., posting 18), update their job posting pipeline, organize candidates 12a into cohorts (i.e., Applied, Rejected, Contacted), initiate/create a hiring plan for reference, schedule/book meetings with candidates 12a, and upload important documents that are pertinent to their recruitment processes.

To improve search capabilities for recruiters 12b, a key word section is provided in the user profile portal 114 (see FIGS. 6-6B, and earlier description) for users 12 (e.g., candidates 12a) to include terms that coincide with their profession or desired career path. For example, if the user 12 is a marketing specialist, the user 12, for example, could include the following terms: marketing specialist, content creation, social media strategy, consumer buying behavior, graphic design, etc. This function of the user profile portal 114 serves as a canvas in which key words and/or phrases are entered, and then a list containing these key words and/or phrases is populated and attached to the profile of the user 12, which can also be searched by a recruiter 12b.

Referring again to FIGS. 6-6B, a user 12 may employ the user profile portal 114 to disclose if they are looking for work, with such status information only being made available to recruiters 12b with accounts 10a on the networking platform 10. Further, according to some embodiments, automatic notifications are sent to a user 12 or candidate 12a when another user 12 or recruiter 12b has an interaction with the live resume (i.e., video resume 50) of the user 12 or candidate 12a, e.g., as depicted in FIGS. 7-7F. For example, when a recruiter 12b views a live resume of a candidate 12a, the candidate 12a can be sent a notification to their central dashboard 112 and/or any devices arranged for pushed messages connected to the networking platform 10.

As described earlier, the live resume (i.e., video resume 50) includes searchable content 60, which can include textual content 62. The textual content 62 can be created through the transcription of audio/video of the raw user-authored video content 61 of the video resume 50. In some embodiments, the following spoken words can be transcribed and provided as underlying text for search engines coupled to the host networking platform software 100. Key terms can be selected for the skills/capabilities portion of the video resume 50 and spoken during the creation of the video resume 50. The software 100 can provide a comprehensive list of suitable keywords for a user to selected during the creation of the video resume 50, along with the capability for a user 12 to add skills not provided in the predetermined list. For example, a marketing analyst, as a user 12 or candidate 12a, may select the following skills labels to add to the video resume 50 to help with searches by recruiters 12b: “Adobe® Creative Cloud”, “Canva”, “graphic design”, “Microsoft® Office®”, and others. These labels are searchable by a recruiter 12b to help narrow down which candidates 12a are best suited for an open position, e.g., open position 18. Matching skills from the profile of a user 12 or candidate 12a to job posting will also help ensure the individual is a good fit for a given position. Notifications with regards to similar job opportunities based off recent application submissions will also be available on the networking platform 10.

Referring again to FIG. 4, according to some embodiments of the host networking platform software 100 of the video-assisted networking platform 10, adaptive graphics can be implemented for those users 12 who are visually impaired. For example, users 12 can adjust the font size and/or color schemes of the central dashboard 112 (along with portals 114-140), as shown in FIG. 4., to suit their preference within the platform 10. The software 100 is contemplated with a screen reader that can enable written text to be read aloud and to provide speech recognition elements to transcribe voice commands and text. Screen magnifiers and tactile notices, such as, for example vibration alerts and notifications can also be included in the central dashboard 112 and portals 114-140 connected to it.

Still referring to FIG. 4, employment opportunities may be accessed through the my jobs portal 118 where a user 12 or candidate 12a may apply to available employment positions listed on the networking platform 10. Once a user 12 or candidate 12a has accessed the my jobs webpage through the my jobs portal 118, the user 12 or candidate 12a is provided access to all available jobs that the user 12 or candidate 12a has either applied for or as marked and saved for later application. During an application process, a user 12 or candidate 12a may go beyond merely submitting a digital resume 51; rather, the individual can submit a video resume 50 that has been prerecorded and saved within the networking platform 10, and even tailored to the particular available position. In one embodiment, the recruiter 12b with an open position 18 can set a video resume format 70 to provide a common approach for video resume 50 creation by candidates 12a for the position 18.

For example, it is contemplated that a user 12 or candidate 12a may apply to an open position 18 merely by clicking on a single button associated with a hiring entity that results in a submission of both a digital resume 51 and a video resume 50. It is believed that this more comprehensive submission provides additional details to the hiring entity, which goes beyond conventional employment application procedures. A standardized application process that is contemplated will provide streamlined application endeavors for the user 12 or candidate 12a that is believed to eliminate customizing applications for various positions as is presently common. It is also believed that a standardized approach for the application process will streamline evaluation by recruiters 12b and employers because multiple candidates may be identified easily by customary search procedures that often fail when applicants do not make available standardized resumes and applications. Furthermore, use of the live resume (i.e., video resume 50) also streamlines hiring processes because recruiters 12b and potential employers may more accurately identify by way of video insight the suitable applicants for the open position 18.

Referring again to the host networking platform software 100 of FIG. 4, prior to beginning the application process through the my jobs web page of the my jobs portal 118, a user 12 identifies available positions through the my jobs portal 118 that provides access to postings made by employers looking to fill positions. A user 12 can then search open positions posted by companies and recruiters 12b on the networking platform 10. Search features allow users 12 to identify relevant positions by way of keyword term searches that provide results that may be further filtered with other search parameters, including but not limited to work requirements, location, and benefits. In addition, search terms may be set to trigger notice to a user 12 of posted employment positions that match a criteria set by a user 12.

Furthermore, the video-assisted networking platform 10 and its host networking platform software 100 provides more than merely networking opportunities. Rather, it can also assist the user 12 in coordinating the user's schedule. For example, as depicted in FIG. 4, a calendar portal 122 enables the user 12 to establish an access schedule for meetings with recruiters 12b and employers. Alternatively, the calendar can be configured to allow a user 12 to schedule conferences with other users 12, mentors, relevant groups, etc., to efficiently balance networking opportunities. Therefore, the networking platform 10 provides users 12 the ability to schedule and coordinating meetings without resorting to the use of other computer applications such as, for example, Microsoft® Outlook®. Thus, the platform 10 fully integrates day-to-day recruitment activities as well as providing simplified procedures for networking and conferencing with recruiters 12b and employers. Notification of scheduled meetings or requests for meetings is provided on the central dashboard 112, as shown in FIG. 4, at least at the time the user accesses the central dashboard 112. Still further, those conducting interviews may access video resumes 50 and other information (e.g., a digital resume 51) of a candidate 12a or user 12 directly from the calendar webpage to reduce the requirement to cycle through various webpages while conducting the interview.

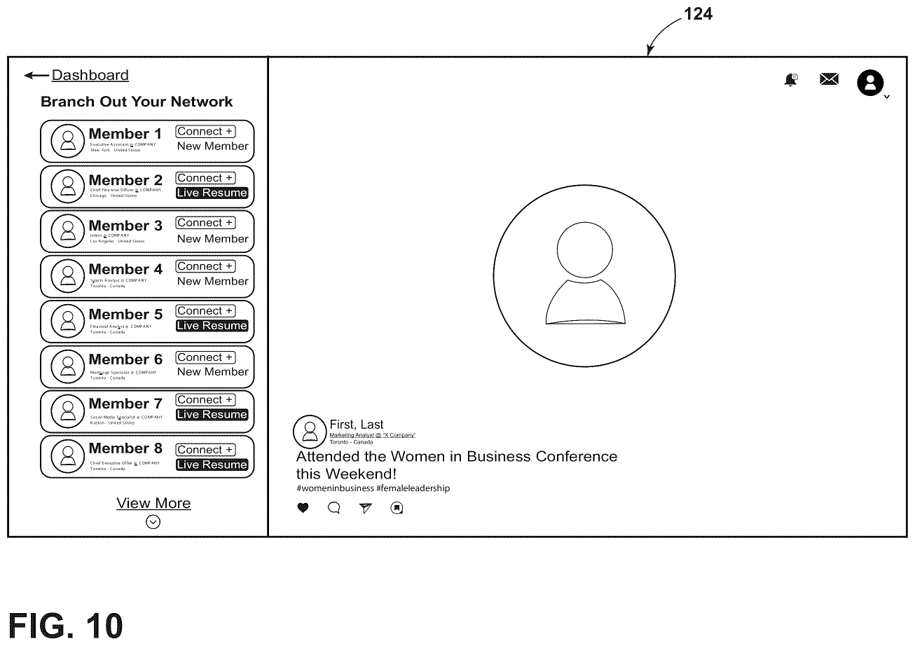

Referring now to FIG. 10, a webpage is depicted of the live feed portal 124 of the central dashboard 112 of the networking platform software 100. According to embodiments, the networking platform 10 provides a capability to identify other users 12 desired to become part of a common user network (e.g., a subset of all of the users 12 with accounts 10a on the networking platform 10). In some implementations, the live feed portal 124 provides access to a live feed web page that simplifies use in identifying credentials of other users 12. For example, the live feed web page presents a split screen identifying other users 12 not part of a network on one side and video resumes 50, written posts, photos, and general information of other users 12 on the opposing side. Interaction and networking by users 12 can be coordinated through the live feed web page providing ease but identification of other users 12 of interest. On the one side of the split screen of the live feed portal 124 (e.g., left side as shown in FIG. 10), users 12 can look at other users 12 on the networking platform 10 who they could potentially connect with to be part of a common user network within the networking platform 10. Accordingly, the platform 10 offers the capability of filtering suitable connections to those users 12 who work in the same industry as the user 12. It should be understood to those of skill in the art that the users 12 can connect with all users 12 on the platform 10 to establish various common user networks within the platform 10.

Referring again to FIG. 10, on the other side of the live feed portal 124 (e.g., right side) of the central dashboard 112 of the host networking platform software 100, a user 12 can view all posts from other users 12, regardless of if the other users 12 are connected on the video-assisted networking platform 10 or not. This is an exemplary method for a user 12 to interact online with the networking platform 10. What is visible to the user 12 is categorized via an algorithm that helps to see more of what they search and digest on a day-to-day basis. Therefore, the algorithm analyzes the viewing habits of the user 12 and renders visible other profiles of users 12 that have a high probability to be of interest to the viewing user 12. In some embodiments of the live feed portal 124, any conventional artificial intelligence algorithms, as understood by those skilled in the field of the disclosure, can be employed by the software 100 to handle foregoing evaluative capabilities of the live feed portal 124.

With further regard to FIG. 10, according to some embodiments of the host networking platform software 100, central editing and posting features are also made available within the live feed portal 124 to each of the users 12. For example, users 12 can choose between a post type (e.g., video, photos, and text posts). Editing features are made available as well so users 12 can edit their posts directly within the video-assisted networking platform 10 on the software 100. In some embodiments, users 12 are able to post their locations, music (with permission, as need be), and other images (with permission, as need be) of interest. Users 12 are able to add hashtags to facilitate easier searching by other users 12, along with various emojis and other quick emotion-driven indicators and actions (e.g., a “like”, a “thumbs-up”, comment, share, save, etc.) for each post.

According to some embodiments of the host networking platform software 100 of the networking platform 10, a separate portal can be used to track users 12 that have been established as part of a particular network of a user 12. In particular, my network portal 126 (see FIG. 4) can provide a method for tracking other users 12 of a network of a user 12 within the networking platform 10. Users 12 of a given network may be searched and located by way of a contact card rather than merely providing a list to improve an experience for the user 12. The ease of identification of users 12 afforded by my network portal 126 can assist a user 12 in establishing a network within the networking platform 10.

According to some embodiments of the host networking platform software 100 of the networking platform 10, additional portals can be implemented to provide career management capabilities to a user. For example, as shown in FIG. 4, a career resources portal 128 can provide access to a career resource webpage, which provides a database for networking and job application advice for each individual user 12. Accessed information may be saved for later consultation by the user 12 within the career resource portal 128.

According to some implementations of the host networking platform software 100 of the networking platform 10, the community forum portal 130 depicted in FIG. 4 provides users 12 with access to a community forum open to discussions and lectures. Further, the community forum is made available to users 12 to both connect with other users 12 and to identify communities of interest. Users 12 may join any community forum of interest where topics are selected and managed by an administrator.

According to some embodiments of the host networking platform software 100 of the networking platform 10, users may also join various groups through a group portal 132 for group interaction, as shown in FIG. 4. The groups within the portal 132 may be selected based upon topic, areas of interest, and specific functions that allow for interaction between users 12, e.g., in a small group format. Group meetings may be ongoing, as scheduled by users 12 of the group or by an administrator that coordinates group topics.

According to some embodiments of the host networking platform software 100 of the networking platform 10, an administrator may also schedule and host events through the event portal 134, as depicted in FIG. 4. Events may include lectures, classes, concerts, and any other event that may garner interest of users 12. Each event may be a pay-per-view session the various users 12 may join. The administrator will coordinate payment received from the users 12 and schedule each event through the event portal 134 and event web page. Access to the event web page is restricted within the event portal 134 to those who have registered and have paid for the event when required. Events may also be linked to a calendar of the user 12 within the calendar portal 122. Events may also appear on the central dashboard 112 of the user 12 when the user 12 has scheduled to attend the event.

According to some embodiments of the host networking platform software 100 of the networking platform 10, an info session portal 136 (see FIG. 4) can provide access for users 12 to informational sessions and webinars hosted by the administrator. Informational sessions may be scheduled at a physical location or be virtual where the user 12 is provided access through the info session portal 136.

According to some embodiments of the host networking platform software 100 of the networking platform 10, a mentor's web page can be accessible through the mentor's portal 138 (see FIG. 4). In these embodiments, users 12 identifying as mentors may be referenced and contacted via a contact card accessible by other users 12. Here, users 12 may identify a mentor that is particularly suited for a unique interest of a user 12. A user 12 may track contact with any of the mentors available on the mentor web page of the mentor's web page portal 138. The administrator may also screen and coordinate mentors seeking to be listed on the mentor web page to ensure that their qualifications meet requirements of the networking platform 10.

According to some embodiments of the host networking platform software 100 of the networking platform 10, a database can be provided that includes newsletters prepared by or posted by the administrator, as accessed through a newsletter portal 140. The database includes records of emails sent to individual users 12 enabling a user 12 to archive and retrieve emails and newsletters when desired.

Aspect 1. A video-assisted networking platform for networking by users with accounts on the platform is provided that includes: a host network platform server; a host networking platform software installed on the server and configured for access by each of the users; and a plurality of video resumes stored on the server, each video resume authored by one of the users and comprising searchable user-authored content in a video resume format specified by the platform software. The host networking platform software is configured such that each video resume can be generated and modified by one of the users. Further, the host networking platform software is configured such that one or more of the users can evaluate each of the plurality of video resumes based at least in part on the searchable user-authored content of each of the video resumes. In addition, the searchable user-authored content is derived from raw user-authored video content. Further, the host networking platform software is configured such that each of the plurality of video resumes can be authenticated by one of the users. The host networking platform software is also configured with a conversion component capable of converting the raw user-authored video content into the searchable user-authored content.

Aspect 2. The networking platform of Aspect 1, wherein the searchable user-authored content comprises textual content.

Aspect 3. The networking platform of Aspect 2, wherein the textual content comprises a plurality of resume topic headings configured to organize the searchable user-authored content.

Aspect 4. The networking platform of Aspect 3, wherein the searchable user-authored content consists of the textual content and processed video content derived from the raw user-authored video content.

Aspect 5. The networking platform of Aspect 3, wherein the textual content further comprises processed textual passages derived from the raw user-authored video content, and wherein the searchable user-authored content consists of the textual content.

Aspect 6. The networking platform of Aspect 1, wherein the host networking platform software is further configured such that a user can evaluate the raw user-authored video content of each of the plurality of video resumes with a machine learning component against a communication-oriented criterion.

Aspect 7. A video-assisted networking platform for candidates and recruiters, each with accounts on the platform, that includes: a host network platform server; a host networking platform software installed on the server and configured for access by each of the candidates and recruiters; and a plurality of video resumes stored on the server, each video resume authored by one of the candidates and comprising searchable user-authored content in a video resume format specified by the platform software, the searchable content comprising textual content. The host networking platform software is configured such that each video resume can be generated and modified by one or more of the candidates. The host networking platform software is configured such that each of the plurality of video resumes can be authenticated by one of the candidates. The host networking platform software is configured such that one of the recruiters associated with an open position can evaluate each of the plurality of video resumes against the open position based at least in part on the searchable user-authored content of each of the plurality of video resumes. The textual content comprises a plurality of resume topic headings configured to organize the searchable user-authored content, and further wherein the resume topic headings can be based on input from the one of the recruiters.

Aspect 8. The networking platform of Aspect 7, wherein the searchable user-authored content is derived from raw user-authored video content, and further wherein the host networking platform software is configured with a conversion component capable of converting the raw user-authored video content into the searchable user-authored content.

Aspect 9. The networking platform of Aspect 8, wherein the searchable user-authored content consists of the textual content and processed video content derived from the raw user-authored video content.

Aspect 10. The networking platform of Aspect 8, wherein the textual content further comprises processed textual passages derived from the raw user-authored video content, and wherein the searchable user-authored content consists of the textual content.

Aspect 11. The networking platform of Aspect 7, further comprising: a plurality of digital resumes stored on the server, each digital resume corresponding to one of the plurality of video resumes, wherein the host networking platform software is further configured such that the one of the recruiters can evaluate each of the plurality of digital resumes against the open position.

Aspect 12. The networking platform of Aspect 7, wherein the searchable user-authored content is derived from raw user-authored video content, and wherein the networking platform software is further configured such that one of the recruiters can evaluate the raw user-authored video content of each of the plurality of video resumes with a machine learning component against a communication-oriented criterion.

Aspect 13. A method of networking using a video-assisted networking platform, the networking platform for networking by candidates and recruiters, each with accounts on the platform, that includes: accessing the networking platform by use of one of the accounts of the recruiters on the platform, the platform comprising a host networking platform software installed on a host network platform server; designating a video resume format on the platform software based at least in part on an open position, the designating conducted during the step of accessing the networking platform by use of one of the accounts of the recruiters; accessing the networking platform by use of one of the accounts of the candidates; recording a video resume using the host networking platform software for storage on the host network platform server, the recording conducted during the step of accessing the networking platform by use of one of the accounts of the candidates; evaluating the video resume against the open position using the host networking software and by accessing the networking platform by use of the one of the accounts of the recruiters; and authenticating the video resume using the host networking platform software, the authenticating conducted during the step of accessing the networking platform by use of one of the accounts of the candidate. The designating a video resume format step is conducted before the recording a video resume step, wherein the video resume comprises searchable user-authored content derived from raw user-authored video content in a video resume format provided by the host networking platform software, and further wherein the evaluating the video resume step is conducted based at least in part on the searchable user-authored content of the video resume.

Aspect 14. The method of networking of Aspect 13, wherein the searchable user-authored content comprises textual content.

Aspect 15. The method of networking of Aspect 14, wherein the textual content comprises a plurality of resume topic headings configured to organize the searchable user-authored content, and further wherein the resume topic headings are based on the open position.

Aspect 16. The method of networking of Aspect 15, wherein the searchable user-authored content consists of the textual content and processed video content derived from the raw user-authored video content.

Aspect 17. The method of networking of Aspect 16, wherein the evaluating step further comprises evaluating the raw user-authored video content of the video resume with a machine learning component of the host networking software against a communication-oriented criterion.

Aspect 18. The networking platform of Aspect 1, wherein the host networking platform software is configured such that each of the plurality of video resumes can be authenticated by one of the users by limiting the raw user-authored video content to generation in one take.

Aspect 19. The networking platform of Aspect 7, wherein the host networking platform software is configured such that each of the plurality of video resumes can be authenticated by one of the candidates by limiting the raw user-authored video content to generation in one take.

Aspect 20. The method of networking of Aspect 13, wherein the authenticating is conducted such that the raw user-authored video content is generated in one take.

Although multiple embodiments of the present disclosure have been illustrated in the accompanying Drawings and described in the foregoing Detailed Description, it should be understood that the invention is not limited to the disclosed embodiments, but instead is also capable of numerous rearrangements, modifications and substitutions without departing from the present disclosure that has been set forth and defined within the following aspects.

What is claimed is:

1. A video-assisted networking platform for networking by users with accounts on the platform, comprising:
a host network platform server;
a host networking platform software installed on the server and configured for access by each of the users; and
a plurality of video resumes stored on the server, each video resume authored by one of the users and comprising searchable user-authored content in a video resume format specified by the platform software,
wherein the host networking platform software is configured such that each video resume can be generated and modified by one of the users,
wherein the host networking platform software is configured such that one or more of the users can evaluate each of the plurality of video resumes based at least in part on the searchable user-authored content of each of the video resumes,
wherein the searchable user-authored content is derived from raw user-authored video content,
wherein the host networking platform software is configured such that each of the plurality of video resumes can be authenticated by one of the users, and
further wherein the host networking platform software is configured with a conversion component capable of converting the raw user-authored video content into the searchable user-authored content.

2. The networking platform of claim 1, wherein the searchable user-authored content comprises textual content.

3. The networking platform of claim 2, wherein the textual content comprises a plurality of resume topic headings configured to organize the searchable user-authored content.

4. The networking platform of claim 3, wherein the searchable user-authored content consists of the textual content and processed video content derived from the raw user-authored video content.

5. The networking platform of claim 3, wherein the textual content further comprises processed textual passages derived from the raw user-authored video content, and wherein the searchable user-authored content consists of the textual content.

6. The networking platform of claim 1, wherein the host networking platform software is further configured such that a user can evaluate the raw user-authored video content of each of the plurality of video resumes with a machine learning component against a communication-oriented criterion.

7. A video-assisted networking platform for candidates and recruiters, each with accounts on the platform, comprising:
a host network platform server;
a host networking platform software installed on the server and configured for access by each of the candidates and recruiters; and
a plurality of video resumes stored on the server, each video resume authored by one of the candidates and comprising searchable user-authored content in a video resume format specified by the platform software, the searchable content comprising textual content,
wherein the host networking platform software is configured such that each video resume can be generated and modified by one or more of the candidates,
wherein the host networking platform software is configured such that each of the plurality of video resumes can be authenticated by one of the candidates,
wherein the host networking platform software is configured such that one of the recruiters associated with an open position can evaluate each of the plurality of video resumes against the open position based at least in part on the searchable user-authored content of each of the plurality of video resumes,
wherein the textual content comprises a plurality of resume topic headings configured to organize the searchable user-authored content, and
further wherein the resume topic headings can be based on input from the one of the recruiters.

8. The networking platform of claim 7, wherein the searchable user-authored content is derived from raw user-authored video content, and further wherein the host networking platform software is configured with a conversion component capable of converting the raw user-authored video content into the searchable user-authored content.

9. The networking platform of claim 8, wherein the searchable user-authored content consists of the textual content and processed video content derived from the raw user-authored video content.

10. The networking platform of claim 8, wherein the textual content further comprises processed textual passages derived from the raw user-authored video content, and wherein the searchable user-authored content consists of the textual content.

11. The networking platform of claim 7, further comprising:
a plurality of digital resumes stored on the server, each digital resume corresponding to one of the plurality of video resumes,
wherein the host networking platform software is further configured such that the one of the recruiters can evaluate each of the plurality of digital resumes against the open position.

12. The networking platform of claim 7, wherein the searchable user-authored content is derived from raw user-authored video content, and wherein the networking platform software is further configured such that one of the recruiters can evaluate the raw user-authored video content of each of the plurality of video resumes with a machine learning component against a communication-oriented criterion.

13. A method of networking using a video-assisted networking platform, the networking platform for networking by candidates and recruiters, each with accounts on the platform, comprising:
accessing the networking platform by use of one of the accounts of the recruiters on the platform, the platform comprising a host networking platform software installed on a host network platform server;
designating a video resume format on the platform software based at least in part on an open position, the designating conducted during the step of accessing the networking platform by use of one of the accounts of the recruiters;
accessing the networking platform by use of one of the accounts of the candidates;
recording a video resume using the host networking platform software for storage on the host network platform server, the recording conducted during the step of accessing the networking platform by use of one of the accounts of the candidates;
evaluating the video resume against the open position using the host networking software and by accessing the networking platform by use of the one of the accounts of the recruiters; and
authenticating the video resume using the host networking platform software, the authenticating conducted during the step of accessing the networking platform by use of one of the accounts of the candidate,
wherein the designating a video resume format step is conducted before the recording a video resume step,
wherein the video resume comprises searchable user-authored content derived from raw user-authored video content in a video resume format provided by the host networking platform software, and
further wherein the evaluating the video resume step is conducted based at least in part on the searchable user-authored content of the video resume.

14. The method of networking of claim 13, wherein the searchable user-authored content comprises textual content.

15. The method of networking of claim 14, wherein the textual content comprises a plurality of resume topic headings configured to organize the searchable user-authored content, and further wherein the resume topic headings are based on the open position.

16. The method of networking of claim 15, wherein the searchable user-authored content consists of the textual content and processed video content derived from the raw user-authored video content.

17. The method of networking of claim 16, wherein the evaluating step further comprises evaluating the raw user-authored video content of the video resume with a machine learning component of the host networking software against a communication-oriented criterion.

18. The networking platform of claim 1, wherein the host networking platform software is configured such that each of the plurality of video resumes can be authenticated by one of the users by limiting the raw user-authored video content to generation in one take.

19. The networking platform of claim 7, wherein the host networking platform software is configured such that each of the plurality of video resumes can be authenticated by one of the candidates by limiting the raw user-authored video content to generation in one take.

20. The method of networking of claim 13, wherein the authenticating is conducted such that the raw user-authored video content is generated in one take.
